(19) United States
(12) Patent Application Publication
(10) Pub. No.: US 2019/0386322 A1
(43) Pub. Date: Dec. 19, 2019

(54) SOLID ELECTROLYTE COMPOSITION, SOLID ELECTROLYTE-CONTAINING SHEET, ALL-SOLID STATE SECONDARY BATTERY, METHODS FOR MANUFACTURING SOLID ELECTROLYTE COMPOSITION, SOLID ELECTROLYTE-CONTAINING SHEET, AND ALL-SOLID STATE SECONDARY BATTERY

(71) Applicant: FUJIFILM Corporation, Tokyo (JP)

(72) Inventors: Toshihiko YAWATA, Ashigarakami-gun (JP); Hiroaki MOCHIZUKI, Ashigarakami-gun (JP); Masaomi MAKINO, Ashigarakami-gun (JP); Tomonori MIMURA, Ashigarakami-gun (JP)

(73) Assignee: FUJIFILM Corporation, Tokyo (JP)

(21) Appl. No.: 16/547,690

(22) Filed: Aug. 22, 2019

Related U.S. Application Data
(63) Continuation of application No. PCT/JP2018/007877, filed on Mar. 1, 2018.

(30) Foreign Application Priority Data
Mar. 14, 2017 (JP) 2017-048865
Jul. 21, 2017 (JP) 2017-142285

(51) Int. Cl. H01M 6/18; H01M 10/0525; H01M 10/0562

(52) U.S. Cl. CPC H01M 6/18; H01M 2300/0068; H01M 10/0562; H01M 10/0525

(57) ABSTRACT

Provided are a solid electrolyte composition containing a sulfide-based inorganic solid electrolyte (A) having a conductivity of an ion of a metal belonging to Group I or II of the periodic table, an organic compound (B) having log P≤1, and a lithium salt (C), in which 0.1 mol or more of the lithium salt (C) is included with respect to 1 mol of the organic compound (B), a solid electrolyte-containing sheet, an all-solid state secondary battery, and methods for manufacturing a solid electrolyte composition, a solid electrolyte-containing sheet, and an all-solid state secondary battery.

### CROSS-REFERENCE TO RELATED APPLICATIONS

This application is a Continuation of PCT International Application No. PCT/JP2018/007877 filed on Mar. 1, 2018, which claims priorities under 35 U.S.C. § 119 (a) to Japanese Patent Application No. 2017-048865 filed in Japan on Mar. 14, 2017 and Japanese Patent Application No. 2017-142285 filed in Japan on Jul. 21, 2017. Each of the above applications is hereby expressly incorporated by reference, in its entirety, into the present application.

### BACKGROUND OF THE INVENTION

### 1. Field of the present invention

The present invention relates to a solid electrolyte composition, a solid electrolyte-containing sheet, an all-solid state secondary battery, and methods for manufacturing a solid electrolyte composition, a solid electrolyte-containing sheet, and an all-solid state secondary battery.

### 2. Description of the Related Art

A lithium ion secondary battery is a storage battery which has a negative electrode, a positive electrode and an electrolyte sandwiched between the negative electrode and the positive electrode and enables charging and discharging by the reciprocal migration of lithium ions between both electrodes. In the related art, an organic electrolytic solution has been used as the electrolyte in lithium ion secondary batteries. However, organic electrolytic solutions are likely to cause liquid leakage, have a concern of the occurrence of a short circuit and ignition in batteries due to overcharging or overdischarging, and are demanded to further improve in terms of safety and reliability.

Under the above-described circumstances, all-solid state secondary batteries in which an inorganic solid electrolyte is used instead of the organic electrolytic solution are attracting attention. In all-solid state secondary batteries, all of the negative electrode, the electrolyte, and the positive electrode are solid, safety and reliability which are considered as a problem of batteries in which the organic electrolytic solution is used can be significantly improved, and it also becomes possible to extend service lives. Furthermore, all-solid state secondary batteries can be provided with a structure in which the electrodes and the electrolyte are directly disposed in series. Therefore, it becomes possible to increase the density of energy to be higher than those of secondary batteries in which the organic electrolytic solution is used, and the application to electric vehicles, large-sized storage batteries, and the like is anticipated.

Due to the respective advantages described above, active research and development is underway to put all-solid state secondary batteries into practical use as next-generation lithium ion batteries, and a number of techniques for improving the performance of all-solid state secondary batteries have been reported. For example, JP2016-033918A discloses that, in a case in which a cross-linked polymer of a cyclic compound having a siloxane bond and an inorganic solid electrolyte including a metal belonging to Group I or II of the periodic table and having an ion conductivity are added to at least one layer of a positive electrode active material layer, a negative electrode active material layer, or a solid electrolyte layer that constitute an all-solid state secondary battery, a decrease in the ion conductivity is suppressed, and it is possible to provide an all-solid state secondary battery that is excellent in terms of moisture resistance and aging stability.

### SUMMARY OF THE PRESENT INVENTION

Regarding the practical use of all-solid state secondary batteries, it becomes important to suppress the degradation of performance in the long-term use of all-solid state secondary batteries. That is, it is important that all-solid state secondary batteries are excellent in terms of cyclic characteristics.

As the above-described inorganic solid electrolyte including a metal belonging to Group I or II of the periodic table and having an ion conductivity, there are an oxide-based inorganic solid electrolyte and a sulfide-based inorganic solid electrolyte. The sulfide-based inorganic solid electrolyte is superior in an ion conductivity to the oxide-based inorganic solid electrolyte and is thus capable of further improving battery performance. However, the sulfide-based inorganic solid electrolyte reacts with water and highly polar dispersion media, which decreases the ion conductivity. In response to the decrease in the ion conductivity, the cycle characteristics of all-solid state secondary batteries also degrade. Therefore, in the case of producing an all-solid state secondary battery having excellent cycle characteristics using the sulfide-based inorganic solid electrolyte, there is a tendency that, as a dispersion medium that is used to prepare a solid electrolyte composition, a dispersion medium having a small polarity is used.

An object of the present invention is to provide a solid electrolyte composition which contains a sulfide-based inorganic solid electrolyte and a compound having a high polarity (log P≤1) that are used in an all-solid state secondary battery and is capable of improving the cycle characteristics of the all-solid state secondary battery. In addition, another object of the present invention is to provide a solid electrolyte-containing sheet which contains a sulfide-based inorganic solid electrolyte that is used in an all-solid state secondary battery and is capable of improving the cycle characteristics of the all-solid state secondary battery. In addition, still another object of the present invention is to provide an all-solid state secondary battery in which the solid electrolyte composition is used. Furthermore, far still another object of the present invention is to provide methods for manufacturing the solid electrolyte composition, the solid electrolyte-containing sheet, and the all-solid state secondary battery.

As a result of intensive studies, the present inventors found that, in a case in which, in a solid electrolyte composition containing a specific sulfide-based inorganic solid electrolyte, a highly polar specific organic compound that acts as a dispersion medium, and a specific amount of a lithium salt, the organic compound is capable of interacting with the lithium salt, it is possible to provide excellent cycle characteristics to an all-solid state secondary battery manufactured using this solid electrolyte composition. The present invention was completed by repeating additional studies on the basis of the above-described finding.

As a result of a variety of studies by the present inventors, the above-described objects were achieved by the following means.
<1> A solid electrolyte composition comprising: a sulfide-based inorganic solid electrolyte (A) having a conductivity of an ion of a metal belonging to Group I or II of the periodic table; an organic compound (B) having log P≤1; and a lithium salt (C),
in which 0.1 mol or more of the lithium salt (C) is included with respect to 1 mol of the organic compound (B), and
in which the organic compound (B) has a cyano group, a hydroxy group, an ester bond, an amide bond, a ketone group, and/or a sulfanyl group (at least one of a cyano group, a hydroxyl group, an ester bond, an amide bond, a ketone group, or a sulfanyl group).
<2> The solid electrolyte composition according to <1>, in which the number of carbon atoms in the organic compound (B) is 1 or more and 5 or less.
<3> A solid electrolyte composition comprising:
a sulfide-based inorganic solid electrolyte (A) having a conductivity of an ion of a metal belonging to Group I or II of the periodic table;
an organic compound (B) having log P≤1; and
a lithium salt (C),
in which 0.1 mol or more of the lithium salt (C) is included with respect to 1 mol of the organic compound (B), and
in which the organic compound (B) has an ether bond.
<4> The solid electrolyte composition according to <3>, in which the number of ether bonds in one molecule of the organic compound (B) is 3 or more and 10 or less.
<5> The solid electrolyte composition according to <4>, in which the organic compound (B) is a compound represented by General Formula (b).

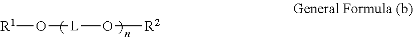

In the formula, R¹ and R² each independently represent a hydrogen atom, an alkyl group, or an aryl group, and L represents an alkylene group or an arylene group. R¹ and R² may bond to each other to form a ring. n represents an integer of 2 or more.
<6> The solid electrolyte composition according to <5>, in which a molecular weight of the organic compound (B) is 100 or more and less than 500.
<7> The solid electrolyte composition according to <5>or <6>, in which, General Formula (b), R¹ and R² each independently represent an alkyl group or an aryl group.
<8> The solid electrolyte composition according to <7>, in which the organic compound (B) is diethylene glycol dimethyl ether, triethylene glycol dimethyl ether, and/or tetraethylene glycol dimethyl ether (at least one of diethylene glycol dimethyl ether, triethylene glycol dimethyl ether, or tetraethylene glycol dimethyl ether).
<9> The solid electrolyte composition according to any one of <1> to <8>, in which a content of water that is included in the organic compound (B) is 1 ppm or more and 1,000 ppm or less on the basis of a mass.
<10> The solid electrolyte composition according to any one of <1> to <9>, further comprising: a binder (D).
<11> The solid electrolyte composition according to any one of <1> to <10>, further comprising: an active material (E).
<12> A solid electrolyte-containing sheet comprising: a sulfide-based inorganic solid electrolyte (A) having a conductivity of an ion of a metal belonging to Group I or II of the periodic table; a substance derived from an organic compound (B) having log P≤1; and a lithium salt (C),
in which 5% by mass or more of the lithium salt (C) is included, and
in which the organic compound (B) has a cyano group, a hydroxy group, an ester bond, an amide bond, a ketone group, and/or a sulfanyl group.
<13> The solid electrolyte-containing sheet according to <12>, in which the number of carbon atoms in the organic compound (B) is 1 or more and 5 or less.
<14> A solid electrolyte-containing sheet comprising:
a sulfide-based inorganic solid electrolyte (A) having a conductivity of an ion of a metal belonging to Group I or II of the periodic table;
a substance derived from an organic compound (B) having log P≤1; and
a lithium salt (C),
in which 5% by mass or more of the lithium salt (C) is included, and
in which the organic compound (B) has an ether bond.
<15> The solid electrolyte-containing sheet according to <14>, in which the number of ether bonds in one molecule of the organic compound (B) is 3 or more and 10 or less.
<16> The solid electrolyte-containing sheet according to <15>, in which the organic compound (B) is a compound represented by General Formula (b).

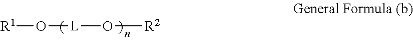

In the formula, R¹ and R² each independently represent a hydrogen atom, an alkyl group, or an aryl group, and L represents an alkylene group or an arylene group. R¹ and R² may bond to each other to form a ring. n represents an integer of 2 or more.
<17> The solid electrolyte-containing sheet according to <16>, in which a molecular weight of the organic compound (B) is 100 or more and less than 500.
<18> The solid electrolyte-containing sheet according to <16> or <17>, in which, General Formula (b), R¹ and R² each independently represent an alkyl group or an aryl group.
<19> The solid electrolyte-containing sheet according to <18>, in which the organic compound (B) is diethylene glycol dimethyl ether, triethylene glycol dimethyl ether, and/or tetraethylene glycol dimethyl ether (at least one of diethylene glycol dimethyl ether, triethylene glycol dimethyl ether, or tetraethylene glycol dimethyl ether).
<20> The solid electrolyte-containing sheet according to any one of <12> to <19>, in which a content of water that is included in the organic compound (B) is 1 ppm or more and 1,000 ppm or less on the basis of a mass.
<21> The solid electrolyte-containing sheet according to any one of <12> to <20>, in which a content of the organic compound (B) is 10 ppm or more and 10,000 ppm or less on the basis of the mass.
<22> The solid electrolyte-containing sheet according to any one of <13> to <21>, further comprising: a binder (D).
<23> The solid electrolyte-containing sheet according to any one of <13> to <22>, further comprising: an active material (E).
<24> An all-solid state secondary battery comprising: a positive electrode active material layer; a negative electrode active material layer; and a solid electrolyte layer, in which at least any of the positive electrode active material layer; the negative electrode active material layer, or the solid electrolyte layer is a layer constituted of the solid electrolyte composition according to any one of <1> to <11>.
<25> A method for manufacturing the solid electrolyte composition according to any one of <1> to <11>, the method comprising steps (1) and (2),
step (1): a step of mixing the organic compound (B) and the lithium salt (C); and
step (2): a step of mixing the mixture obtained in the step (1) and the sulfide-based inorganic solid electrolyte (A).
<26> A method for manufacturing a solid electrolyte-containing sheet, the method comprising: applying the solid electrolyte composition according to any one of <1> to <11> onto a base material; and drying the solid electrolyte composition.
<27> A method for manufacturing an all-solid state secondary battery, the method comprising: manufacturing an all-solid state secondary battery having the solid electrolyte-containing sheet using the manufacturing method according to <26>.

In the description of the present invention, “the substance derived from the organic compound (B) having log P≤1” refers to the organic compound (B) having log P≤1, the organic compound (B) having a layer coated with the sulfide-based inorganic solid electrolyte, a solvated salt obtained by interaction between the organic compound (B) having log P≤1 and a lithium salt, an oxidized body and an reduced body of the organic compound (B) having log P≤1, and a reaction product between the organic compound (B) and lithium.

In the description of the present invention, a numerical range expressed using “to” refers to a numerical range including numerical values before and after “to” as the lower limit value and the upper limit value.

In the description of the present invention, the mass-average molecular weight can be measured as a polystyrene-equivalent molecular weight by means of gel permeation chromatography (GPC) unless particularly otherwise described. At this time, a GPC apparatus HLC-8220 (trade name, manufactured by Tosoh Corporation) is used, G3000HXL+G2000HXL (all trade names, manufactured by Tosoh Corporation) are used as columns, a flow rate at 23° C. is 1 mL/min, and the molecular weight is detected by RI. An eluent can be selected from tetrahydrofuran (THF), chloroform, N-methyl-2-pyrrolidone (NMP), and m-cresol/chloroform (manufactured by Shonanwako Junyaku KK), and THF is used in a case in which a subject needs to be dissolved.

The solid electrolyte composition of the present invention is capable of improving the cycle characteristics of an all-solid state secondary battery by being used to produce the all-solid state secondary battery. In addition, the solid electrolyte-containing sheet of the present invention is capable of improving the cycle characteristics of an all-solid state secondary battery by being used in the all-solid state secondary battery. In addition, the all-solid state secondary battery of the present invention is excellent in terms of cycle characteristics. Furthermore, according to the method for manufacturing the solid electrolyte composition of the present invention, the method for manufacturing the solid electrolyte-containing sheet of the present invention, and the method for manufacturing the all-solid state secondary battery of the present invention, it is possible to manufacture the solid electrolyte composition, the solid electrolyte-containing sheet, and the all-solid state secondary battery which have excellent performance.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating an all-solid state secondary battery (coin battery) produced in examples.

### DESCRIPTION OF THE PREFERRED EMBODIMENTS

### <Preferred Embodiment>

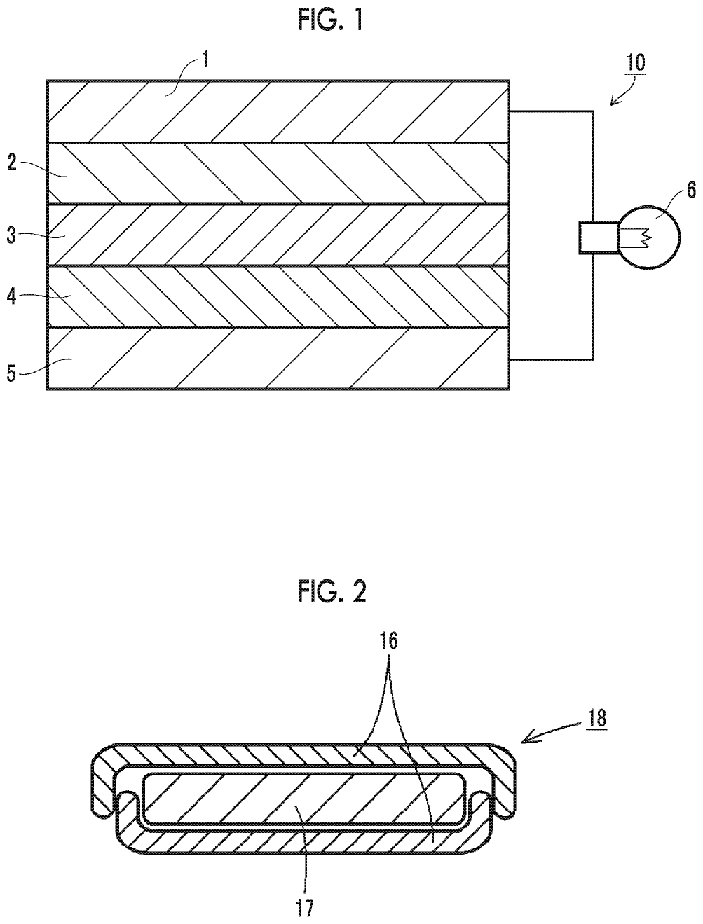

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with one another and have a laminated structure. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging.

A solid electrolyte composition of the embodiment of the present invention can be preferably used as a material used to shape the negative electrode active material layer, the solid electrolyte layer, and/or the positive electrode active material layer. In addition, a solid electrolyte-containing sheet of the embodiment of the present invention is preferred as the negative electrode active material layer, the solid electrolyte layer, and/or the positive electrode active material layer.

In the present specification, the positive electrode active material layer (hereinafter, also referred to as the positive electrode layer) and the negative electrode active material layer (hereinafter, also referred to as the negative electrode layer) will be collectively referred to as the electrode layer or the active material layer in some cases.

In addition, an all-solid state secondary battery having a layer constitution of FIG. 1 will also be referred to as an all-solid state secondary battery sheet in some cases.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm. In the all-solid state secondary battery of the embodiment of the present invention, the thickness of at least one layer of the positive electrode active material layer 4, the solid electrolyte layer 3, or the negative electrode active material layer 2 is still more preferably 50 μm or more and less than 500 μm.

### <Solid Electrolyte Composition>

The solid electrolyte composition of the embodiment of the present invention includes a sulfide-based inorganic solid electrolyte (A) having a conductivity of an ion of a metal belonging to Group I or II of the periodic table, an organic compound (B) having log P≤1, and a lithium salt (C), and 0.1 mol or more of the lithium salt (C) is included with respect to 1 mol of the organic compound (B).

Hereinafter, “the sulfide-based inorganic solid electrolyte (A) having a conductivity of an ion of a metal belonging to Group I or II of the periodic table” will be referred to as “the sulfide-based inorganic solid electrolyte (A)” in some cases. In addition, “the organic compound (B) having log P≤1” will be referred to as “the organic compound (B)” in some cases. In addition, the respective components that are included in the solid electrolyte composition will be described with no references presented thereto like simply “the sulfide-based inorganic solid electrolyte” in some cases.

Hereinafter the respective components in the composition will be described in detail.

### (Sulfide-Based Inorganic Solid Electrolyte (A))

The solid electrolyte composition of the embodiment of the present invention contains a sulfide-based inorganic solid electrolyte (A).

The inorganic solid electrolyte is a solid electrolyte that is inorganic, and the solid electrolyte refers to a solid-form electrolyte capable of migrating ions therein. The inorganic solid electrolyte is clearly differentiated from organic solid electrolytes (high-molecular-weight electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion-conductive material. In addition, the inorganic solid electrolyte is a solid in a static state and is thus, generally, not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of ions of metals belonging to Group I or II of the periodic table and is generally a substance not having electron conductivity.

As the inorganic solid electrolyte, it is possible to appropriately select and use solid electrolyte materials that are applied to this kind of products. Typical examples of the inorganic solid electrolyte include (i) a sulfide-based inorganic solid electrolyte and (ii) an oxide-based inorganic solid electrolyte. In the present invention, the sulfide-based inorganic solid electrolyte is used.

The sulfide-based inorganic solid electrolyte that is used in the present invention is preferably an inorganic solid electrolyte which contains a sulfur atom (S), has an ion conductivity of a metal belonging to Group I or II of the periodic table, and has an electron-insulating property. The sulfide-based inorganic solid electrolyte is preferably an inorganic solid electrolyte which, as elements, contains at least Li, S, and P and has a lithium ion conductivity, but the sulfide-based inorganic solid electrolyte may also include elements other than Li, S, and P depending on the purposes or cases.

Examples thereof include lithium ion-conductive sulfide-based inorganic solid electrolytes satisfying a composition represented by Formula (I).

Lₐ₁M_{b1}P_{c1}S_{d1}Aₑ₁ Formula (I)

In the formula, L represents an element selected from Li, Na, and K and is preferably Li. M represents an element selected from B, Zn, Sn, Si, Cu, Ga, Sb, Al, and Ge. A represents an element selected from I, Br, Cl, and F. a1 to e1 represent the compositional fractions among the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3. Furthermore, d1 is preferably 2.5 to 10 and more preferably 3.0 to 8.5. Furthermore, e1 is preferably 0 to 5 and more preferably 0 to 3.

The compositional fractions among the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolyte can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case in which the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂, and the like. Here, the mixing ratios between the respective raw materials do not matter. Examples of a method for synthesizing the sulfide-based inorganic solid electrolyte material using the above-described raw material compositions include an amorphorization method. Examples of the amorphorization method include a mechanical milling method, a solution method, and a melting quenching method. This is because these treatments are possible at normal temperature (25° C.) and manufacturing steps can be simplified.

The volume-average particle diameter of the sulfide-based inorganic solid electrolyte is not particularly limited, but is preferably 0.01 μm or more and more preferably 0.1 μm or more. The upper limit is preferably 100 μm or less and more preferably 50 μm or less. Meanwhile, the average particle diameter of sulfide-based inorganic solid electrolyte particles is measured in the following order. A 1% by mass dispersion liquid of the sulfide-based inorganic solid electrolyte particles is prepared through dilution and adjustment using water (heptane in a case in which the inorganic solid electrolyte particles are unstable in water) in a 20 ml sample bottle. The diluted dispersed specimen is irradiated with 1 kHz ultrasonic waves for 10 minutes and then immediately used for testing. Data are captured 50 times using this dispersion liquid specimen, a laser diffraction/scattering-type particle size distribution measurement instrument LA-920 (manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis-Dynamic light scattering method” is referred to as necessary. Five specimens are produced per level, and the average value thereof is employed.

In a case in which a decrease in the interface resistance and the maintenance of the decreased interface resistance when used in an all-solid state secondary battery are taken into account, the content of the sulfide-based inorganic solid electrolyte in the solid components of the solid electrolyte composition is preferably 5% by mass or more, more preferably 10% by mass or more, and particularly preferably 15% by mass or more with respect to 100% by mass of the solid components. From the same viewpoint, the upper limit is preferably 99.9% by mass or less, more preferably 99.5% by mass or less, and particularly preferably 99% by mass or less.

The sulfide-based inorganic solid electrolyte may be used singly or two or more sulfide-based inorganic solid electrolytes may be used in combination.

Meanwhile, in the present specification, the solid content (solid component) refers to a component that does not disappear by volatilization or evaporation in the case of being dried in a nitrogen atmosphere at 80° C. for six hours. Typically, the solid content refers to a component other than a dispersion medium described below.

### (Oxide-Based Inorganic Solid Electrolyte)

The solid electrolyte composition of the embodiment of the present invention may also contain an oxide-based inorganic solid electrolyte in addition to the sulfide-based inorganic solid electrolyte (A) as long as the effect of the present invention is exhibited. The oxide-based inorganic solid electrolyte is preferably a compound which contains an oxygen atom (O), has an ion conductivity of a metal belonging to Group I or II of the periodic table, and has an electron-insulating property.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤md≤2, and nb satisfies 5≤nb20.), Li_{xc}B_{yc}M^{cc}_{zc}O_{nc} (M^{cc} is at least one element of C, S, Al, Si, Ga, Ge, In, or Sn, xc satisfies 0≤xc≤5, yc satisfies 0≤yc≤1, zc satisfies 0≤zc≤1, and nc satisfies ≤nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li₍₃₋₂ₓₑ₎M^{ee}ₓₑD^{ee}O (xe represents a number of 0 or more and 0.1 or less, and M^{ee} represents a divalent metal atom. D^{ee} represents a halogen atom or a combination of two or more halogen atoms.), Li_{xf}Si_{yf}O_{zf} (1≤xf≤5, 0≤yf≤3, 1≤zf≤10), Li_{xg}S_{yg}O_{zg} (1≤xg≤3, 0<yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}Nₙ (w satisfies w<1), Li_{3.5}Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), Li₇La₃Zr₂O₁₂ (LLZ) having a garnet-type crystal structure. In addition, phosphorus compounds containing Li, P and O are also desirable. Examples thereof include lithium phosphate (Li₃PO₄), LiPON in which some of oxygen atoms in lithium phosphate are substituted with nitrogen, LiPOD¹ (D¹ is at least one element selected from Ti, V, Cr, Mn, Fe, Co, Ni, Cu, Zr, Nb, Mo, Ru, Ag, Ta, W, Pt, Au, or the like), and the like. It is also possible to preferably use LiA¹ON (A¹ represents at least one element selected from Si, B, Ge, Al, C, Ga, or the like) and the like.

Regarding the volume-average particle diameter of the oxide-based inorganic solid electrolyte and a measuring method therefor, it is possible to preferably apply the description of the volume-average particle diameter of the sulfide-based inorganic solid electrolyte (A) and the manufacturing method therefor.

(Organic compound (B))

The organic compound (B) that is used in the solid electrolyte composition of the embodiment of the present invention is not particularly limited as long as log P is equal to or less than 1. The lower limit of the log P value is not particularly limited, but practically −4 or more. Meanwhile, the Log P value is a value computed using ChemBioDraw (trade name) Version: 12.9.2.1076 manufactured by PerkinElmer Inc. The organic compound (B) acts as a dispersion medium.

The organic compound (B) is preferably a compound having a cyano group, a hydroxy group, an ester bond, an amide bond, a ketone group, and/or a sulfanyl group since this compound favorably coordinates to the lithium salt (ion), is capable of interacting with the sulfide-based inorganic solid electrolyte and an active material, and exhibits a preferable ion conductivity. Meanwhile, in the description of the present invention, a compound having an amide bond and a carbonate group is not regarded as a compound having a ketone group.

Specific examples of the compound having a cyano group include acetonitrile, propionitrile, isopropionitrile, butyronitrile, isobutyronitrile, valeronitrile, isovaleronitrile, pivalonitrile, hexanenitrile, heptane nitrile, malononitrile, and succinonitrile.

Specific examples of the compound having a hydroxy group include ethanol, triethylene glycol, methanol, propanol, isopropanol, butanol, isobutanol, phenol, benzyl alcohol, tert-butanol, and hexanol.

Specific examples of the compound having an ester bond include ethyl acetate, methyl acetate, propyl acetate, isopropyl acetate, butyl acetate, isobutyl acetate, methyl propionate, ethyl propionate, propyl propionate, isopropyl propionate, butyl propionate, isobutyl propionate, methyl butyrate, ethyl butyrate, propyl butyrate, isopropyl butyrate, butyl butyrate, isobutyl butyrate, tert-butyl butyrate, methyl formate, ethyl formate, propyl formate, isopropyl formate, butyl formate, butyl formate, isobutyl formate, γ-butyrolactone, γ-valerolactone, δ-valerolactone, ϵ-caprolactone, methyl benzoate, and ethyl benzoate. Meanwhile, in the description of the present invention, the compound having an ester bond is not classified into a compound having a ketone group and a compound having an ether bond.

Specific examples of the compound having an amide bond include N-methyl-2-pyrrolidone (NMP), N-ethyl-2-pyrrolidone, dimethylacetamide, dimethylimidazolidinone, and dimethylformamide.

Specific examples of the compound having a ketone group include acetone, ethyl methyl ketone, diethyl ketone, methyl isopropyl ketone, methyl isobutyl ketone, 2-pentanone, 2-hexanone, 3-hexanone, diisopropyl ketone, cyclohexanone, acetophenone, and diisobutyl ketone.

Meanwhile, in the description of the present invention, the compound having a carbonate group is not classified into a compound having a ketone group, a compound having an ester bond, and a compound having an ether bond.

Specific examples of the compound having a sulfanyl group include propanethiol, butanethiol, isobutylmercaptan, 3-methyl 2-butanethiol, isoamyl mercaptan, 2-methyl-1-butanethiol, and hexanedithiol.

The organic compound (B) is also preferably a compound having an ether bond since the compound favorably coordinates to the lithium salt (ion), is capable of interacting with the sulfide-based inorganic solid electrolyte and an active material, and exhibits a preferable ion conductivity. Meanwhile, in the description of the present invention, “—O-” in the ester bond and “—O-” in the carbonate group are not regarded as the ether bond.

The compound having an ether bond is preferably a compound having two or more ether bonds in one molecule and more preferably has three or more ether bonds. The upper limit is not particularly limited, but is preferably 100 or less, more preferably 50 or less, and particularly preferably 10 or less. In a case in which the number of ether bonds in one molecule is in the above-described range, it becomes possible to further increase the ion conductivity. This is considered to be because it becomes possible to stabilize lithium ions of the lithium salt at a plurality of ether bond portions and the interaction of the lithium salt with an anion is weakened.

The compound having an ether bond is capable of more effectively coordinating to a lithium ion using the ether bond portions and is thus preferably a compound represented by General Formula (b).

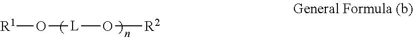

In the formula, R¹ and R² each independently represent a hydrogen atom, an alkyl group, or an aryl group, and L represents an alkylene group or an arylene group. R¹ and R² may bond to each other to form a ring. n represents an integer of 2 or more. R¹, R², and L may have a substituent.

R¹ and R² each independently preferably represent an alkyl group or an aryl group and more preferably represent an alkyl group since the group is considered to be efficiently coordinated to a lithium ion and, furthermore, is electrochemically stable.

The number of carbon atoms in the alkyl group is preferably 1 to 10, more preferably 1 to 6, and particularly preferably 1 or 2. Specific examples of the alkyl group include methyl, ethyl, t-butyl, i-propyl, and cyclohexyl.

The number of carbon atoms in the aryl group is preferably 6 to 20, more preferably 6 to 13, and particularly preferably 6 to 8. Specific examples of the aryl group include phenyl and naphtyl.

L preferably represents an alkylene group.

The number of carbon atoms in the alkylene group represented by L is preferably 1 to 10, more preferably 1 to 6, and particularly preferably 1 to 3. Specific examples of the alkylene group include methylene, ethylene, and propylene.

The number of carbon atoms in the arylene group represented by L is preferably 6 to 20, more preferably 6 to 13, and particularly preferably 6 to 8. Specific examples of the arylene group include phenylene and naphthylene.

As descried above, R¹ and R² may bond to each other to form a ring. This ring is preferably a 6- to 24-membered ring and more preferably a 6- to 15-membered ring and may be a ring formed by the fusion of the above-described rings.

The upper limit of n is not particularly limited, but is preferably an integer of 20 or less, more preferably an integer of 9 or less, and particularly preferably 4 or less.

Specific examples of the substituent that R¹, R², and L may have include a substituent P described below.

The interaction between the organic compound (B) and the lithium salt (C) is capable of increasing the ion conductivity. The lower limit of the molecular weight of the organic compound (B) is preferably 50 or more and more preferably 100 or more. The upper limit is preferably less than 2,000 and more preferably less than 500. The molecular weight is particularly preferably 100 or more and less than 500. In a case in which the molecular weight of the organic compound (B) is in the above-described range, the organic compound is capable of more effectively interacting with a lithium ion through a coordinate bond. In addition, the organic compound (B) has an appropriate viscosity and is capable of further increasing the ion conductivity.

As the compound having an ether bond, diethyl ether, diisopropyl ether, t-butyl methyl ether, ethylene glycol, ethylene glycol dimethyl ether, dibutyl ether, diethylene glycol dimethyl ether, tetraethylene glycol dimethyl ether (tetraglyme), triethylene glycol dimethyl ether (triglyme), tetraethylene glycol monomethyl ether, triethylene glycol monomethyl ether, tetraethylene glycol, triethylene glycol, and the like are exemplified.

Among these, diethylene glycol dimethyl ether, tetraethylene glycol dimethyl ether (tetraglyme), triethylene glycol dimethyl ether (triglyme), tetraethylene glycol monomethyl ether, triethylene glycol monomethyl ether, tetraethylene glycol, and triethylene glycol are preferred, and diethylene glycol dimethyl ether, tetraethylene glycol dimethyl ether, triethylene glycol dimethyl ether are more preferred since it is possible to efficiently coordinate a lithium ion.

The organic compound (B) may be used singly or two or more dispersion media may be used in combination.

As the polarity of the molecule becomes higher, the organic compound (B) is more likely to coordinate to the lithium salt. In addition, it is considered that the interaction with the sulfide-based inorganic solid electrolyte improves the ion conductivity, and thus the number of carbon atoms in the organic compound (B) is particularly preferably 1 or more. The upper limit of the number of carbon atoms is not particularly limited, but is preferably 12 or less, more preferably 8 or less, and particularly preferably 5 or less.

The organic compound (B) that is used in the present invention is considered to interact with the lithium salt (C) as described below, and thus the solid electrolyte composition of the embodiment of the present invention is capable of exhibiting the effect even in a case in which the content of moisture in the organic compound (B) is 1 ppm or more and 1,000 ppm or less on the basis of the mass.

### (Lithium Salt (C))

The lithium salt (C) that can be used in the present invention is preferably a lithium salt that is ordinarily used in this kind of product and is not particularly limited, and, for example, lithium salts described below are preferred.

(C-1) Inorganic lithium salts: inorganic fluoride salts such as LiPF₆, LiBF₄, LiAsF₆, and LiSbF₆; perhalogen acid salts such as LiClO₄, LiBrO₄, and LiIO₄; inorganic chloride salts such as LiAlCl₄; and the like.

(C-2) Fluorine-containing organic lithium salts: perfluoroalkanesulfonate salts such as LiCF₃SO₃; perfluoroalkanesulfonylimide salts such as LiN(CF₃SO₂)₂ [LiTFSI], LiN(CF₃CF₂SO₂)₂ [LiBETI], LiN(FSO₂)₂ [LiFSI], and LiN(CF₃SO₂) (C₄F₉SO₂); perfluoroalkanesulfonylmethide salts such as LiC(CF₃SO₂)₃; fluoroalkylfluoride phosphate salts such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], Li[PF₃(CF₂CF₂CF₂CF₃)₃]; and the like.

(C-3) Oxalatoborate salts: lithium bis(oxalato)borate, lithium difluorooxalatoborate, and the like.

Among these, LiBF₄, LiTFSI, LiBETI, and LiFSI are preferred.

Meanwhile, the lithium salt may be used singly or two or more lithium salts may be used in random combination.

The content of the lithium salt is 0.1 mol or more, preferably 0.3 mol or more, and more preferably 0.5 mol or more with respect to 1 mol of the organic compound (B). The upper limit is preferably 1.5 mol or less and more preferably 1 mol or less. In a case in which the content of the lithium salt is less than 0.1 mol with respect to 1 mol of the organic compound (B), there are a number of polar substituents in the organic compound (B) that does not coordinate to the lithium salt (C), and thus the lithium salt can be a component that reacts with the sulfide-based inorganic solid electrolyte and increases the resistance of the all-solid state secondary battery.

In the solid electrolyte composition of the embodiment of the present invention, it is considered that the organic compound (B) and the lithium salt (C) interact with each other. The form of the interaction is not particularly limited and is considered as a form in which the lithium salt is solvated by the organic compound (B) and a form in which the organic compound (B) and the lithium salt (C) form a coordinate bond and is complexed. As described above, it is considered that the interaction between the organic compound (B) and the lithium salt (C) is capable of suppressing the reaction between the sulfide-based inorganic solid electrolyte and the organic compound (B) and suppressing a decrease in the ion conductivity of the sulfide-based inorganic solid electrolyte.

The solid electrolyte composition of the embodiment of the present invention may also contain a compound other than the organic compound (B) (hereinafter, also referred to as the “second dispersant”), that is, a dispersion medium having a log P value of more than 1 as long as the organic compound (B) and the lithium salt (C) are included in a state in which both components are capable of interacting with each other. The dispersion medium having a log P value of more than 1 is not particularly limited, and examples thereof include hexane (3.0), butyronitrile (1.24), dibutyl ether (2.57), and diisopropyl ketone (2.64).

### (Ionic Liquid)

The solid electrolyte composition of the embodiment of the invention may also contain an ionic liquid in order to further improve the ion conductivity of the solid electrolyte-containing sheet and the cycle characteristics of the all-solid state secondary battery. The ionic liquid is not particularly limited, but is preferably an ionic liquid dissolving the above-described lithium salt (C). Examples thereof include compounds made of a combination of a cation and an anion described below.

### (i) Cation

Examples of the cation include an imidazolium cation, a pyridinium cation, a piperidinium cation, a pyrrolidinium cation, a morpholinium cation, a phosphonium cation, a quaternary ammonium cation, and the like. Here, these cations have a substituent described below.

As the cation, these cations may be used singly or two or more cations may be used in combination.

As the cation, a quaternary ammonium cation, a piperidinium cation, or a pyrrolidinium cation is preferred.

As the substituent that the cation has, an alkyl group (preferably having 1 to 8 carbon atoms and more preferably having 1 to 4 carbon atoms), a hydroxyalkyl group (preferably having 1 to 3 carbon atoms), an alkyloxyalkyl group (preferably having 2 to 8 carbon atoms and more preferably having 2 to 4 carbon atoms), a group having an ether bond (a group having at least one ether bond in a carbon chain of the above-described alkyl group), an allyl group, an aminoalkyl group (preferably having 1 to 8 carbon atoms and more preferably having 1 to 4 carbon atoms), and an aryl group (preferably having 6 to 12 carbon atoms and more preferably having 6 to 8 carbon atoms) are exemplified. The substituent may form a cyclic structure in a form of containing a cation site. The substituent may also have a substituent P described below.

### (ii) Anion

Examples of the anion include a chloride ion, a bromide ion, an iodide ion, a boron tetrafluoride ion, a nitric acid ion, a dicyanamide ion, an acetate ion, an iron tetrachloride ion, a bis(trifluoromethanesulfonyl)imide ion, a bis(fluorosulfonyl)imide ion, a bis(perfluorobutylmethanesulfonyl)imide ion, an allylsulfonate ion, a hexafluorophosphate ion, a trifluoromethanesulfonate ion, and the like.

As the anion, these anions may be used singly or two or more anions may also be used in combination.

A boron tetrafluoride ion, a bis(trifluoromethanesulfonyl)imide ion, a bis(fluorosulfonyl)imide ion, a hexafluorophosphate ion, a dicyanamide ion, or an allylsulfonate ion is preferred, and a bis(trifluoromethanesulfonyl)imide ion, a bis(fluorosulfonyl)imide ion, or an allylsulfonate ion is more preferred.

Examples of the ionic liquid include 1-allyl-3-ethylimidazolium bromide, 1-ethyl-3-methylimidazolium bromide, 1-(2-hydroxyethyl)-3-methylimidazolium bromide, 1-(2-methoxyethyl)-3-methylimidazolium bromide, 1-octyl-3-methylimidazolium chloride, N,N-diethyl-N-methyl-N-(2-methoxyethyl)ammonium tetrafluoroborate, 1-ethyl-3-methylimidazolium bis(trifluoromethanesulfonyl)imide, 1-ethyl-3-methylimidazolium bis(fluorosulfonyl)imide, 1-ethyl-3-methylimidazolium dicyanamide, 1-butyl-1-methylpyrrolidinium bis(trifluoromethanesulfonyl)imide, trimethylbutylammonium bis(trifluoromethanesulfonyl)imide, N,N-diethyl-N-methyl-N-(2-methoxyethyl) ammonium bis(trifluoromethanesulfonyl)imide, N-(2-methoxyethyl)-N-methylpyrrolidinium tetrafluoroboride, 1-butyl-1-methylpyrrolidinium imidazolium bis(fluorosulfonyl)imide, (2-acryloylethyl) trimethylammonium bis(trifluoromethanesulfonyl)imide, 1-ethyl-1-methylpyrrolidinium allyl sulfonate, 1-ethyl-3-methylimidazolium allylsulfonate, and trihexyltetradecylphosphonium chloride.

The content of the ionic liquid is preferably 0 parts by mass or more, more preferably 1 part by mass or more, and most preferably 2 part by mass or more with respect to 100 parts by mass of the inorganic solid electrolyte. The upper limit is preferably 50 parts by mass or less and more preferably 20 parts by mass or less.

The mass ratio between the lithium salt and the ionic liquid (lithium salt:ionic liquid) is preferably 1:20 to 20:1, more preferably 1:10 to 10:1, and most preferably 1:5 to 2:1.

Examples of the substituent P include the following substituents.
an alkyl group (preferably an alkyl group having 1 to 20 carbon atoms, for example, methyl, ethyl, isopropyl, t-butyl, isobutyl, pentyl, heptyl, 1-ethylpentyl, benzyl, 2-ethoxyethyl, 1-carboxymethyl, or the like), an alkenyl group (preferably an alkenyl group having 2 to 20 carbon atoms, for example, vinyl, allyl, oleyl, or the like), an alkynyl group (preferably an alkynyl group having 2 to 20 carbon atoms, for example, ethynyl, butadiynyl, phenylethynyl, or the like), a cycloalkyl group (preferably a cycloalkyl group having 3 to 20 carbon atoms, for example, cyclopropyl, cyclopentyl, cyclohexyl, 4-methylcyclohexyl, or the like; here, in the case of being referred to as an alkyl group in the present specification, generally, a cycloalkyl group is also referred to), an aryl group (preferably an aryl group having 6 to 26 carbon atoms, for example, phenyl, 1-naphthyl, 4-methoxyphenyl, 2-chlorophenyl, 3-methylphenyl, or the like), an aralkyl group (preferably an aralkyl group having 7 to 23 carbon atoms, for example, benzyl, phenethyl, or the like), a heterocyclic group (preferably a heterocyclic group having 2 to 20 carbon atoms, preferably a 5- or 6-membered heterocyclic group having at least one selected from an oxygen atom, a sulfur atom, or a nitrogen atom as a ring-constituting atom, for example, tetrahydropyranyl, tetrahydrofuranyl, 2-pyridyl, 4-pyridyl, 2-imidazolyl, 2-benzimidazolyl, 2-thiazolyl, 2-oxazolyl, pyrrolidone group, or the like), an alkoxy group (preferably an alkoxy group having 1 to 20 carbon atoms, for example, methoxy, ethoxy, isopropyloxy, benzyloxy, or the like), an aryloxy group (preferably an aryloxy group having 6 to 26 carbon atoms, for example, phenoxy, 1-naphthyloxy, 3-methylphenoxy, 4-methoxyphenoxy, or the like; here, in the case of being referred to as an alkoxy group in the present specification, generally, an aryloyl group is also referred to), an alkoxycarbonyl group (preferably an alkoxycarbonyl group having 2 to 20 carbon atoms, for example, ethoxycarbonyl, 2-ethylhexyloxycarbonyl, or the like), an aryloxycarbonyl group (preferably an aryloxycarbonyl group having 6 to 26 carbon atoms, for example, phenoxycarbonyl, 1-naphthyloxycarbonyl, 3-methylphenoxycarbonyl, 4-methoxyphenoxycarbonyl, or the like), an amino group (preferably an amino group, alkylamino group, or arylamino group having 0 to 20 carbon atoms, for example, amino, N,N-dimethylamino, N,N-diethylamino, N-ethylamino, anilino, or the like), a sulfamoyl group (preferably a sulfamoyl group having 0 to 20 carbon atoms, for example, N,N-dimethylsulfamoyl, N-phenylsulfamoyl, or the like), an acyl group (preferably an acyl group having 1 to 20 carbon atoms, for example, acetyl, propionyl, butyryl, or the like), an aryloyl group (preferably an aryloyl group having 7 to 23 carbon atoms, for example, benzoyl or the like; here, in the case of being referred to as an acyl group in the present specification, generally, an aryloyl group is also referred to), an acyloxy group (preferably an acyloxy group having 1 to 20 carbon atoms, for example, acetyloxy, or the like), an aryloyloxy group (preferably an aryloyloxy group having 7 to 23 carbon atoms, for example, benzoyloxy, or the like; here, in the case of being referred to as an acyloxy group in the present specification, generally, an aryloyloxy group is also referred to), a carbamoyl group (preferably a carbamoyl group having 1 to 20 carbon atoms, for example, N,N-dimethylcarbamoyl, N-phenylcarbamoyl, or the like), an acylamino group (preferably an acylamino group having 1 to 20 carbon atoms, for example, acetylamino, benzoylamino, or the like), an alkylsulfanyl group (preferably an alkylsulfanyl group having 1 to 20 carbon atoms, for example, methylsulfanyl, ethylsulfanyl, isopropylsulfanyl, benzylsulfanyl, or the like), an arylsulfanyl group (preferably an arylsulfanyl group having 6 to 26 carbon atoms, for example, phenylsulfanyl, 1-naphthylsulfanyl, 3-methylphenylsulfanyl, 4-methoxyphenylsulfanyl, or the like), an alkylsulfonyl group (preferably an alkylsulfonyl group having 1 to 20 carbon atoms, for example, methylsulfonyl, ethylsulfonyl, or the like), an arylsulfonyl group (preferably an arylsulfonyl group having 6 to 22 carbon atoms, for example, benzenesulfonyl or the like), an alkylsilyl group (preferably an alkylsilyl group having 1 to 20 carbon atoms, for example, monomethylsilyl, dimethylsilyl, trimethylsilyl, triethylsilyl, or the like), an arylsilyl group (preferably an arylsilyl group having 6 to 42 carbon atoms, for example, triphenylsilyl or the like), an alkoxysilyl group (preferably an alkoxysilyl group having 1 to 20 carbon atoms, for example, monomethoxysilyl, dimethoxysilyl, trimethoxysilyl, triethoxysilyl, or the like), an aryloxysilyl group (preferably an aryloxysilyl group having 6 to 42 carbon atoms, for example, triphenyloxysilyl or the like), a phosphoyl group (preferably a phosphoryl group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a (meth)acryloyl group, a (meth)acryloyloxy group, a (meth)acryloylimino group (a (meth)acrylamide group), a hydroxy group, a sulfanyl group, a carboxy group, a phosphate group, a phosphate group, a sulfonic acid group, a cyano group, and a halogen atom (for example, a fluorine atom, a chlorine atom, a bromine atom, an iodine atom, or the like).

In addition, in the respective groups exemplified as the substituent P, the substituent P may be further substituted.

In a case in which a compound, a substituent, a linking group, and the like has an alkyl group, an alkylene group, an alkenyl group, an alkenylene group, an alkynyl group, an alkynylene group, and/or the like, the compound, the substituent, the linking group, and the like may have a cyclic shape or a chain shape, may be linear or branched, and may be substituted or unsubstituted as described above.

### (Binder (D))

The solid electrolyte composition of the embodiment of the invention preferably contains a binder (D) (hereinafter, also referred to as the binder) since the bonding property between solid particles and between the respective layers that constitute the all-solid state secondary battery improves.

The binder that is used in the solid electrolyte composition of the embodiment of the present invention is not particularly limited as long as the binder is an organic polymer.

Binders that can be used in the present invention are not particularly limited, and, for example, binders consisting of a resin described below are preferred.

Examples of fluorine-containing resins include polytetrafluoroethylene (PTFE), polyvinylene difluoride (PVdF), and copolymers of polyvinylene difluoride and hexafluoropropylene (PVdF-HFP).

Examples of hydrocarbon-based thermoplastic resins include polyethylene, polypropylene, styrene butadiene rubber (SBR), hydrogenated styrene butadiene rubber (HSBR), butylene rubber, acrylonitrile butadiene rubber, polybutadiene, polyisoprene, polyisoprene latex, and the like.

Examples of acrylic resins include a variety of (meth)acrylic monomers, (meth)acrylic amide monomers, and copolymers of monomers constituting these resins.

In addition, copolymers with other vinyl-based monomers are also preferably used. Examples thereof include copolymers of methyl poly(meth)acrylate and polystyrene, copolymers of methyl poly(meth)acrylate and acrylonitrile, and copolymers of butyl poly(meth)acrylate, acrylonitrile, and styrene.

Examples of other resins include a polyurethane resin, a polyurea resin, a polyamide resin, a polyimide resin, a polyester resin, a polyether resin, a polycarbonate resin, a cellulose derivative resin, and the like.

These binders may be used singly or two or more binders may be used in combination.

The shape of the binder that is used in the present invention is not particularly limited and may have a particle shape or an irregular shape in the all-solid state secondary battery.

The moisture concentration of the polymer constituting the binder that is used in the present invention is preferably 100 ppm (on the basis of the mass) or less.

In addition, the polymer constituting the binder that is used in the present invention may be used in a solid state or may be used in a state of a polymer particle dispersion liquid or a polymer solution at the time of forming the solid electrolyte-containing sheet or the all-solid state secondary battery.

The mass-average molecular weight of the binder constituting the binder that is used in the present invention is preferably 10,000 or more, more preferably 20,000 or more, and still more preferably 30,000 or more. The upper limit is preferably 1,000,000 or less, more preferably 200,000 or less, and still more preferably 100,000 or less.

### —Measurement of Molecular Weight—

Unless particularly otherwise described, the molecular weight of the binder in the present invention refers to the mass-average molecular weight, and the standard polystyrene-equivalent mass-average molecular weight is measured by means of gel permeation chromatography (GPC). Regarding a measurement method, basically, a value measured using a method under the following conditions 1 or conditions 2 (preferential) is used. Here, an appropriate eluent may be appropriately selected and used depending on the kind of the binder.

### (Conditions 1)

Column: Two TOSOH TSKgel Super AWM-H (trade name) are connected together
Carrier: 10 mM LiBr/N-methyl pyrrolidone
Measurement temperature: 40° C.
Carrier flow rate: 1.0 mL/min
Specimen concentration: 0.1% by mass
Detector: Refractive index (RI) detector

### (Conditions 2) Preferential

Column: A column obtained by connecting TOSOH TSKgel Super HZM-H (trade name), TOSOH TSKgel Super HZ4000 (trade name), and TOSOH TSKgel Super HZ 2000 (trade name) is used
Carrier: Tetrahydrofuran
Measurement temperature: 40° C.
Carrier flow rate: 1.0 mL/min
Specimen concentration: 0.1% by mass
Detector: Refractive index (RI) detector
   (Active material (E))

The solid electrolyte composition of the embodiment of the present invention may also contain an active material (E) capable of intercalating and deintercalating an ion of a metal element belonging to Group I or II of the periodic table. Hereinafter, the active material (E) will also be simply referred to as the active material.

As the active material, a positive electrode active material and a negative electrode active material are exemplified, and a transition metal oxide that is a positive electrode active material and lithium titanate or graphite that is a negative electrode active material are preferred.

In the present invention, the solid electrolyte composition containing the active material (a positive electrode active material or a negative electrode active material) will be referred to as a composition for an electrode (a composition for a positive electrode or a composition for a negative electrode).

### —Positive Electrode Active Material—

A positive electrode active material that the solid electrolyte composition of the embodiment of the present invention may contain is preferably a positive electrode active material capable of reversibly intercalating and deintercalating lithium ions. The above-described material is not particularly limited as long as the material has the above-described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (an element of Group I (Ia) of the metal periodic table other than lithium, an element of Group II (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a reaches} 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like. In the present invention, the transition metal oxides having a bedded salt-type structure (MA) are preferred.

Specific examples of the transition metal oxides having a bedded salt-type structure (MA) include LiCoO₂ (lithium cobalt oxide [LCO]), LiNiO₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ (lithium iron phosphate [LFP]) and Li₃Fe₂(PO₄)₃, iron pyrophosphates such as LiFeP₂O₇, and cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, the transition metal compounds having the lithium-containing transition metal phosphoric acid compounds (MC) are preferred, olivine-type iron phosphate salts are more preferred, and LFP is still more preferred.

The shape of the positive electrode active material is not particularly limited, but is preferably a particle shape. The volume-average particle diameter (circle-equivalent average particle diameter) of positive electrode active material particles is not particularly limited. For example, the volume-average particle diameter can be set to 0.1 to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter (circle-equivalent average particle diameter) of positive electrode active material particles can be measured using a laser diffraction/scattering-type particle size distribution measurement instrument LA-920 (trade name, manufactured by Horiba Ltd.).

The positive electrode active material may be used singly or two or more positive electrode active materials may be used in combination.

In the case of forming a positive electrode active material layer, the mass (mg) of the positive electrode active material per unit area (cm²) of the positive electrode active material layer (weight per unit area) is not particularly limited and can be appropriately determined depending on the set battery capacity.

The content of the positive electrode active material in the solid electrolyte composition is not particularly limited, but is preferably 10% to 95% by mass, more preferably 30% to 90% by mass, still more preferably 50% to 85% by mass, and particularly preferably 55% to 80% by mass with respect to a solid content of 100% by mass.

### —Negative Electrode Active Material—

A negative electrode active material that the solid electrolyte composition of the embodiment of the present invention may contain is preferably a negative electrode active material capable of reversibly intercalating and deintercalating lithium ions. The above-described material is not particularly limited as long as the material has the above-described characteristics, and examples thereof include carbonaceous materials, metal oxides such as tin oxide, silicon oxide, metal complex oxides, a lithium single body, lithium alloys such as lithium aluminum alloys, metals capable of forming alloys with lithium such as Sn, Si, Al, and In and the like. Among these, carbonaceous materials or metal complex oxides are preferably used in terms of reliability. In addition, the metal complex oxides are preferably capable of absorbing and deintercalating lithium. The materials are not particularly limited, but preferably contain titanium and/or lithium as constituent components from the viewpoint of a high-current density charging and discharging characteristic.

The carbonaceous material that is used as the negative electrode active material is a material substantially consisting of carbon. Examples thereof include petroleum pitch, carbon black such as acetylene black (AB), graphite (natural graphite, artificial graphite such as highly oriented pyrolytic graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 20 value in a range of 20° to 40° in an X-ray diffraction method in which CuKa rays are used and may have crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Bi₂O₄, SnSiO₃, GeS, SnS, SnS₂, PbS, PbS₂, Sb₂S₃, Sb₂S₅, and SnSiS₃. In addition, these amorphous oxides may be complex oxides with lithium oxide, for example, Li₂SnO₂.

The negative electrode active material preferably contains a titanium atom. More specifically, Li₄Ti₅O₁₂ (lithium titanium oxide [LTO]) is preferred since the volume fluctuation during the absorption and deintercalation of lithium ions is small, and thus the high-speed charging and discharging characteristic is excellent, and the deterioration of electrodes is suppressed, whereby it becomes possible to improve the service lives of lithium ion secondary batteries.

In the present invention, a Si-based negative electrode is also preferably applied. Generally, a Si negative electrode is capable of absorbing a larger number of Li ions than a carbon negative electrode (graphite, acetylene black, or the like). That is, the amount of Li ions absorbed per unit mass increases. Therefore, it is possible to increase the battery capacity. As a result, there is an advantage that the battery driving duration can be extended.

The shape of the negative electrode active material is not particularly limited, but is preferably a particle shape. The average particle diameter of the negative electrode active material is preferably 0.1 μm to 60 μm. In order to provide a predetermined particle diameter, an ordinary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out. The average particle diameter of negative electrode active material particles can be measured using the same method as the method for measuring the volume-average particle diameter of the positive electrode active material.

The chemical formulae of the compounds obtained using a firing method can be computed using an inductively coupled plasma (ICP) emission spectroscopic analysis method as a measurement method from the mass difference of powder before and after firing as a convenient method.

The negative electrode active material may be used singly or two or more negative electrode active materials may be used in combination.

In the case of forming a negative electrode active material layer, the mass (mg) of the negative electrode active material per unit area (cm²) in the negative electrode active material layer (weight per unit area) is not particularly limited and can be appropriately determined depending on the set battery capacity.

The content of the negative electrode active material in the solid electrolyte composition is not particularly limited, but is preferably 10% to 80% by mass and more preferably 20% to 80% by mass with respect to a solid content of 100% by mass.

The surfaces of the positive electrode active material and/or the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, lithium niobate-based compounds, and the like, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, B₂O₃, and the like.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an active light ray or an active gas (plasma or the like) before or after the coating of the surfaces.

### (Conductive Auxiliary Agent)

The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene which are electron-conductive materials and also may be metal powder or a metal fiber of copper, nickel, or the like, and a conductive polymer such as polyaniline, polypyrrole, polythiophene, polyacetylene, or a polyphenylene derivative may also be used. In addition, these conductive auxiliary agents may be used singly or two or more conductive auxiliary agents may be used.

In the present invention, in the case of jointly using the negative electrode active material and the conductive auxiliary agent, a conductive auxiliary agent which does not cause the intercalation and deintercalation of Li during the charging and discharging of batteries and does not function as the negative electrode active material is used as the conductive auxiliary agent. Therefore, among conductive auxiliary agents, conductive auxiliary agents capable of functioning as a negative electrode active material in negative electrode active material layers during the charging and discharging of batteries are classified not as the conductive auxiliary agent but as the negative electrode active material. Whether or not a conductive auxiliary agent functions as a negative electrode active material during the charging and discharging of batteries cannot be unambiguously determined and is determined by the combination with a negative electrode active material.

The content of the conductive auxiliary agent in the solid electrolyte composition of the embodiment of the present invention is not particularly limited, but is preferably 0.1% to 15% by mass and more preferably 0.5% to 5% by mass with respect to 100% by mass of the solid component.

### (Dispersant)

The solid electrolyte composition of the embodiment of the present invention may also contain a dispersant. The addition of the dispersant enables the suppression of the agglomeration of the active material and the sulfide-based inorganic solid electrolyte even in a case in which the concentration of any of the electrode active material and the inorganic solid electrolyte is high or a case in which the particle diameters are small and the surface area increases and the formation of a uniform active material layer and a uniform solid electrolyte layer. As the dispersant, a dispersant that is ordinarily used for an all-solid state secondary battery can be appropriately selected and used. Generally, a compound intended for particle adsorption and steric repulsion and/or electrostatic repulsion is preferably used.

### (Preparation of Solid Electrolyte Composition)

The solid electrolyte composition of the embodiment of the present invention can be obtained as a slurry containing the sulfide-based inorganic solid electrolyte (A), the organic compound (B), and the lithium salt (C) through the following steps (1) and (2).

### Step (1):

A step of mixing the organic compound (B) and the lithium salt (C); and

### Step (2):

A step of mixing the mixture obtained in the step (1) and the sulfide-based inorganic solid electrolyte (A).

A mixing device in the step (1) is not particularly limited, and examples thereof include a stirrer. The mixing conditions are not particularly limited, but the organic compound and the lithium salt are preferably mixed together at 100 to 1,500 rotations per minute (rpm) at 20° C. to 70° C. for 0.5 hours to two hours.

A mixing device in the step (2) is not particularly limited, and examples thereof include a ball mill, a beads mill, a planetary mixer, a blade mixer, a roll mill, a kneader, and a disc mill. The mixing conditions are not particularly limited; however, in the case of using a ball mill, the inorganic solid electrolyte and the dispersion medium are preferably mixed together at 150 to 700 rpm for one hour to 24 hours.

In the case of preparing a solid electrolyte composition containing components such as the active material (E), the conductive auxiliary agent, and a particle dispersant, the components may be added to and mixed with at the same time as the dispersion step of the sulfide-based inorganic solid electrolyte (A) in the step (2) or may be added to and mixed with separately from the dispersion step in the step (2).

### [Solid Electrolyte-Containing Sheet]

A solid electrolyte-containing sheet of an embodiment of the present invention includes a sulfide-based inorganic solid electrolyte (A) having a conductivity of an ion of a metal belonging to Group I or II of the periodic table, a substance derived from an organic compound (B) having log P≤1, and a lithium salt (C), and 5% by mass or more of the lithium salt (C) is included.

Regarding the sulfide-based inorganic solid electrolyte (A), the organic compound (B), the lithium salt (C), and random components, it is possible to employ the above description.

The content of the lithium salt (C) is 5% by mass or more, preferably 6% by mass or more, and more preferably 7% by mass or more. The upper limit is not particularly limited, but is practically 30% by mass or less. In a case in which the substance derived from the organic compound (B) having log P≤1 and the lithium salt (C) are included in the solid electrolyte-containing sheet of the embodiment of the present invention in the above-described range, in the solid electrolyte-containing sheet containing the active material, it is considered that the substance and the lithium salt block pores in the interfaces between the inorganic solid electrolyte particles. Therefore, it is considered that, compared with an all-solid state secondary battery produced using a solid electrolyte composition in which an ordinary non-polar solvent is used, the inorganic solid electrolyte particles that follow the expansion and contraction of the active material are present, and lithium ions are conducted even between blocked pores, and thus it is possible to improve the conductivity and improve the cycle characteristics of the all-solid state secondary battery.

The solid electrolyte-containing sheet of the embodiment of the present invention can be preferably used in all-solid state secondary batteries and is modified in a variety of aspects depending on the uses. As the solid electrolyte-containing sheet that is used in the all-solid state secondary battery, for example, a sheet that is preferably used in a solid electrolyte layer (also referred to as a solid electrolyte sheet for an all-solid state secondary battery) and a sheet that is preferably used in an electrode or a laminate of an electrode and a solid electrolyte layer (an electrode sheet for an all-solid state secondary battery) are exemplified, and the solid electrolyte-containing sheet of the embodiment of the present invention is preferably used as an electrode sheet for an all-solid state secondary battery. In the present invention, a variety of sheets described above will be collectively referred to as a sheet for an all-solid state secondary battery in some cases.

The sheet for an all-solid state secondary battery is a sheet having a solid electrolyte layer or an active material layer (electrode layer), and examples thereof include an aspect of a sheet having a solid electrolyte layer or an active material layer (electrode layer) on a base material. Hereinafter, this aspect of the sheet will be described in detail.

This sheet for an all-solid state secondary battery may further have other layers as long as the sheet has the base material and the solid electrolyte layer or the active material layer, but a sheet containing an active material is classified into an electrode sheet for an all-solid state secondary battery described below. Examples of other layers include a protective layer, a collector, a coating layer (a collector, a solid electrolyte layer, or an active material layer), and the like.

Examples of the solid electrolyte sheet for an all-solid state secondary battery include a sheet having a solid electrolyte layer and a protective layer on a base material in this order.

The base material is not particularly limited as long as the base material is capable of supporting the solid electrolyte layer, and examples thereof include sheet bodies (plate-like bodies) of materials, organic materials, inorganic materials, and the like described in the section of the collector described below. Examples of the organic materials include a variety of polymers and the like, and specific examples thereof include polyethylene terephthalate, polypropylene, polyethylene, cellulose, and the like. Examples of the inorganic materials include glass, ceramic, and the like.

The layer thickness of the solid electrolyte layer in the sheet for an all-solid state secondary battery is identical to the layer thickness of the solid electrolyte layer described in the section of an all-solid state secondary battery of the embodiment of the present invention.

This sheet is obtained by forming a film of the solid electrolyte composition for forming the solid electrolyte layer (by means of application and drying) on the base material (possibly, through other layers) and forming a solid electrolyte layer on the base material.

Here, the solid electrolyte composition of the embodiment of the present invention can be prepared using the above-described method.

An electrode sheet for an all-solid state secondary battery of the embodiment of the present invention (also simply referred to as “the electrode sheet”) is a sheet for forming an active material layer in an all-solid state secondary battery and an electrode sheet having an active material layer on a metal foil as a collector. This electrode sheet is generally a sheet having a collector and an active material layer, and an aspect of having a collector, an active material layer, and a solid electrolyte layer in this order and an aspect of having a collector, an active material layer, a solid electrolyte layer, and an active material layer in this order are also considered as the electrode sheet.

The layer thicknesses of the respective layers constituting the electrode sheet are identical to the layer thicknesses of individual layers described in the section of an all-solid state secondary battery of the embodiment of the present invention. In addition, the constitution of the respective layers constituting the electrode sheet is identical to the constitution of individual layers described in the section of an all-solid state secondary battery of the embodiment of the present invention described below.

The electrode sheet is obtained by forming a film of the solid electrolyte composition of the embodiment of the present invention (by means of application and drying) on the metal foil and forming an active material layer on the metal foil.

Meanwhile, it is also possible to produce a solid electrolyte-containing sheet consisting of only the solid electrolyte layer or the active material layer by peeling the base material after the formation of the solid electrolyte layer or the active material layer.

### [All-Solid State Secondary Battery]

An all-solid state secondary battery of the embodiment of the present invention has a positive electrode, a negative electrode facing the positive electrode, and a solid electrolyte layer between the positive electrode and the negative electrode. The positive electrode has a positive electrode active material layer on a positive electrode collector. The negative electrode has a negative electrode active material layer on a negative electrode collector.

At least one layer of the positive electrode active material layer, the solid electrolyte layer, or the negative electrode active material layer is preferably formed using the solid electrolyte composition of the embodiment of the present invention.

Preferably, the kinds and the content ratios of the components that the positive electrode active material layer, the solid electrolyte layer, and the negative electrode active material layer formed using the solid electrolyte composition of the embodiment of the present invention are basically the same as those of the solid contents of the solid electrolyte composition.

In addition, the positive electrode active material layer, the solid electrolyte layer, and the negative electrode active material layer may also contain the organic compound (B) to an extent to which the battery performance is not affected, and the content thereof is preferably 10 ppm or more and 10,000 ppm on the basis of the mass. Meanwhile, the content proportion of the dispersion medium (C) in the active material layer of the all-solid state secondary battery of the embodiment of the present invention can be measured with reference to a method described in the section of the examples described below.

Hereinafter, a preferred embodiment of the embodiment of the present invention will be described with reference to FIG. 1, but the present invention is not limited thereto.

### [Positive Electrode Active Material Layer, Solid Electrolyte Layer, and Negative Electrode Active Material Layer]

In the all-solid state secondary battery 10, at least one layer of the positive electrode active material layer, the solid electrolyte layer, or the negative electrode active material layer is produced using the solid electrolyte composition of the embodiment of the present invention.

In a case in which the positive electrode active material layer 4 and/or the negative electrode active material layer 2 are produced using the solid electrolyte composition of the embodiment of the present invention containing an active material, the positive electrode active material layer 4 and the negative electrode active material layer 2 respectively include a positive electrode active material or a negative electrode active material and further include the sulfide-based inorganic solid electrolyte (A), a substance derived from the organic compound (B), and the lithium salt (C).

The kinds of the sulfide-based inorganic solid electrolyte (A), the substance derived from the organic compound (B), and the lithium salt (C) that the positive electrode active material layer 4, the solid electrolyte layer 3, and the negative electrode active material layer 2 contain may be identical to or different from each other.

In the present invention, at least one layer of the positive electrode active material layer, the solid electrolyte layer, or the negative electrode active material layer in the all-solid state secondary battery is a layer that is produced using the solid electrolyte composition containing the sulfide-based inorganic solid electrolyte (A), the organic compound (B), and the lithium salt (C) and contains the sulfide-based inorganic solid electrolyte (A), the organic compound (B), and the lithium salt (C).

### [Collector (Metal Foil)]

The positive electrode collector 5 and the negative electrode collector 1 are preferably an electron conductor.

In the present invention, there are cases in which any or both of the positive electrode collector and the negative electrode collector will be simply referred to as the collector.

As a material forming the positive electrode collector, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred, and, among these, aluminum and an aluminum alloy are more preferred.

As a material forming the negative electrode collector, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred, and aluminum, copper, a copper alloy, or stainless steel is more preferred.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 to 500 μm. In addition, the surface of the collector is preferably provided with protrusions and recesses by means of a surface treatment.

In the present invention, a functional layer, member, or the like may be appropriately interposed or disposed between the respective layers of the negative electrode collector, the negative electrode active material layer, the solid electrolyte layer, the positive electrode active material layer, and the positive electrode collector or on the outside thereof. In addition, the respective layers may be composed of a single layer or multiple layers.

### [Chassis]

It is possible to produce the basic structure of the all-solid state secondary battery by disposing the respective layers described above. Depending on the use, the basic structure may be directly used as an all-solid state secondary battery, but the basic structure may be used after being enclosed in an appropriate chassis in order to have a dry battery form. The chassis may be a metallic chassis or a resin (plastic) chassis. In a case in which a metallic chassis is used, examples thereof include an aluminum alloy chassis and a stainless-steel chassis. The metallic chassis is preferably classified into a positive electrode-side chassis and a negative electrode-side chassis and electrically connected to the positive electrode collector and the negative electrode collector respectively. The positive electrode-side chassis and the negative electrode-side chassis are preferably integrated by being joined together through a gasket for short circuit prevention.

### [Manufacturing of Solid Electrolyte-Containing Sheet]

The solid electrolyte-containing sheet of the embodiment of the present invention is obtained by forming a film of the solid electrolyte composition of the embodiment of the present invention on a base material (possibly, through a different layer) (application and drying) and forming a solid electrolyte layer on the base material.

With the above-described aspect, it is possible to produce a solid electrolyte-containing sheet having a layer containing the sulfide-based inorganic solid electrolyte (A), the substance derived from the organic compound (B), and the lithium salt (C) on a base material.

Additionally, regarding steps such as application, it is possible to use a method described in the following section of the manufacturing of an all-solid state secondary battery.

Meanwhile, the solid electrolyte-containing sheet of the embodiment of the present invention contains the organic compound (B) in the layer as long as the battery performance is not affected. A preferred content thereof is 10 ppm or more and 10,000 ppm or less on the basis of the mass.

Meanwhile, the content proportion of the substance derived from the organic compound (B) in the layer of the solid electrolyte-containing sheet of the embodiment of the present invention can be computed using a method described in the section of examples.

### [All-Solid State Secondary Battery and Manufacturing of Electrode Sheet for All-Solid State Secondary Battery]

The all-solid state secondary battery and the electrode sheet for an all-solid state secondary battery can be manufactured using an ordinary method. Specifically, the all-solid state secondary battery and the electrode sheet for an all-solid state secondary battery can be manufactured by forming the respective layers described above using the solid electrolyte composition of the embodiment of the present invention or the like. Hereinafter, the manufacturing method will be described in detail.

The all-solid state secondary battery of the embodiment of the present invention can be manufactured using a method including (through) a step of applying the solid electrolyte composition of the embodiment of the present invention onto a base material (for example, a metal foil which serves as a collector) and forming a coated film (film manufacturing).

For example, a solid electrolyte composition containing a positive electrode active material is applied as a material for a positive electrode (a composition for a positive electrode) onto a metal foil which is a positive electrode collector so as to form a positive electrode active material layer, thereby producing a positive electrode sheet for an all-solid state secondary battery. Next, a solid electrolyte composition for forming a solid electrolyte layer is applied onto the positive electrode active material layer so as to form a solid electrolyte layer. Furthermore, a solid electrolyte composition containing a negative electrode active material is applied as a material for a negative electrode (a composition for a negative electrode) onto the solid electrolyte layer so as to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can be produced by enclosing the all-solid state secondary battery in a chassis as necessary.

In addition, it is also possible to manufacture an all-solid state secondary battery by carrying out the methods for forming the respective layers in a reverse order so as to form a negative electrode active material layer, a solid electrolyte layer, and a positive electrode active material layer on a negative electrode collector and overlaying a positive electrode collector thereon.

As another method, the following method can be exemplified. That is, a positive electrode sheet for an all-solid state secondary battery is produced as described above. In addition, a solid electrolyte composition containing a negative electrode active material is applied as a material for a negative electrode (a composition for a negative electrode) onto a metal foil which is a negative electrode collector so as to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer so that the solid electrolyte layer and the active material layer come into contact with each other. An all-solid state secondary battery can be manufactured as described above.

As still another method, the following method can be exemplified. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, a solid electrolyte composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated together so as to sandwich the solid electrolyte layer that has been peeled off from the base material. An all-solid state secondary battery can be manufactured as described above.

An all-solid state secondary battery can be manufactured by combining the above-described forming methods. For example, a positive electrode sheet for an all-solid state secondary battery, a negative electrode sheet for an all-solid state secondary battery, and a solid electrolyte sheet for an all-solid state secondary battery are produced respectively. Next, a solid electrolyte layer peeled off from a base material is laminated on the negative electrode sheet for an all-solid state secondary battery and is then attached to the positive electrode sheet for an all-solid state secondary battery, whereby an all-solid state secondary battery can be manufactured. In this method, it is also possible to laminate the solid electrolyte layer on the positive electrode sheet for an all-solid state secondary battery and attach the solid electrolyte layer to the negative electrode sheet for an all-solid state secondary battery.

### (Formation of Individual Layers (Film Formation))

The method for applying the solid electrolyte composition is not particularly limited and can be appropriately selected. Examples thereof include coating (preferably wet-type coating), spray coating, spin coating, dip coating, slit coating, stripe coating, and bar coating.

At this time, the solid electrolyte composition may be dried after being applied or may be dried after being applied to multiple layers. The drying temperature is not particularly limited. The lower limit is preferably 30° C. or higher, more preferably 60° C. or higher, and still more preferably 80° C. or higher, and the upper limit is preferably 300° C. or lower, more preferably 250° C. or lower, and still more preferably 200° C. or lower. In a case in which the compositions are heated in the above-described temperature range, it is possible to remove the organic compound (B) other than pores and form a solid state. In addition, the temperature is not excessively increased, and the respective members of the all-solid state secondary battery are not impaired, which is preferable. Therefore, in the all-solid state secondary battery, excellent total performance is exhibited, and it is possible to obtain a favorable bonding property.

After the application of the solid electrolyte composition to the base material or the production of the all-solid state secondary battery, the respective layers or the all-solid state secondary battery is preferably pressurized. In addition, the respective layers are also preferably pressurized in a state of being laminated together. Examples of the pressurization method include a hydraulic cylinder pressing machine and the like. The welding pressure is not particularly limited, but is, generally, preferably in a range of 50 to 1,500 MPa.

In addition, the applied solid electrolyte composition may be heated at the same time as pressurization. The heating temperature is not particularly limited, but is generally in a range of 30° C. to 300° C. The respective layers or the all-solid state secondary battery can also be pressed at a temperature higher than the glass transition temperature of the sulfide-based inorganic solid electrolyte.

Meanwhile, the respective compositions may be applied at the same time, and the application, the drying, and the pressing may be carried out simultaneously and/or sequentially. The respective compositions may be applied to separate base materials and then laminated by means of transfer.

The atmosphere during the pressurization is not particularly limited and may be any one of in the atmosphere, under the dried air (the dew point: −20° C. or lower), in an inert gas (for example, in an argon gas, in a helium gas, or in a nitrogen gas), or the like.

The pressing time may be a short time (for example, within several hours) at a high pressure or a long time (one day or longer) under the application of an intermediate pressure. In the case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure can be changed depending on the area or film thickness of the portion under pressure. In addition, it is also possible to change the same portion with a pressure that varies stepwise.

A pressing surface may be flat or roughened.

### (Initialization)

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

### [Uses of All-Solid State Secondary Battery]

The all-solid state secondary battery of the embodiment of the present invention can be applied to a variety of uses. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer uses include automobiles (electric cars and the like), electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military uses and universe uses. In addition, the all-solid state secondary battery can also be combined with solar batteries.

According to the preferred embodiment of the present invention, individual application forms as described below are derived.
[1] An all-solid state secondary battery in which all layers of a positive electrode active material layer, a solid electrolyte layer, and a negative electrode active material layer are layers constituted of the solid electrolyte composition of the embodiment of the present invention.
[2] A solid electrolyte composition containing the sulfide-based inorganic solid electrolyte (A), the organic compound (B), the lithium salt (C), and a second dispersion medium.
[3] A kit for preparing a solid electrolyte composition consisting of a container containing the organic compound (B) and the lithium salt (C) and a container containing the sulfide-based inorganic solid electrolyte (A).
[4] A solid electrolyte composition prepared from the kit for preparing a solid electrolyte composition.
[5] An electrode sheet for an all-solid state secondary battery obtained by applying any of the solid electrolyte composition onto a metal foil to form a film.
[6] A method for manufacturing an electrode sheet for an all-solid state secondary battery in which any of the solid electrolyte composition is applied onto a metal foil to form a film.

The container that is used for the kit for preparing a solid electrolyte composition is not particularly limited. As a container containing the organic compound (B) and the lithium salt (C), for example, a glass container, a metal container (a SUS container, an aluminum container, or the like), and a plastic container (TEFLON (registered trademark) container, a polyethylene container, a polypropylene container, a polyethylene terephthalate (PET) container, or a polycarbonate container) are exemplified. The organic compound (B) and the lithium salt (C) may be mixed together before being put into the container or may be mixed together after being put into the container and before being mixed with the sulfide-based inorganic solid electrolyte. Meanwhile, as the container containing the sulfide-based inorganic solid electrolyte (A), it is possible to use an ordinary container that seals the sulfide-based inorganic solid electrolyte.

All-solid state secondary batteries refer to secondary batteries having a positive electrode, a negative electrode, and an electrolyte which are all composed of solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (high-molecular-weight) all-solid state secondary batteries in which a high-molecular-weight compound such as polyethylene oxide is used as an electrolyte and inorganic all-solid state secondary batteries in which the Li—P—S-based glass, LLT, LLZ, or the like is used. Meanwhile, the application of organic compounds to inorganic all-solid state secondary batteries is not inhibited, and organic compounds can also be applied as binders or additives of positive electrode active materials, negative electrode active materials, and inorganic solid electrolytes.

Inorganic solid electrolytes are differentiated from electrolytes in which the above-described high-molecular-weight compound is used as an ion conductive medium (high-molecular-weight electrolyte), and inorganic compounds serve as ion conductive media. Specific examples thereof include the Li—P—S glass, LLT, and LLZ. Inorganic solid electrolytes do not emit positive ions (Li ions) and exhibit an ion transportation function. In contrast, there are cases in which materials serving as an ion supply source which is added to electrolytic solutions or solid electrolyte layers and emits positive ions (Li ions) are referred to as electrolytes; however, in the case of being differentiated from electrolytes as the ion transportation materials, the materials are referred to as “electrolyte salts” or “supporting electrolytes”. Examples of the electrolyte salts include LiTFSI.

In the present invention, “compositions” refer to mixtures obtained by uniformly mixing two or more components. Here, compositions may partially include agglomeration or uneven distribution as long as the compositions substantially maintain uniformity and exhibit desired effects.

### EXAMPLES

Hereinafter, the present invention will be described in more detail on the basis of examples. Meanwhile, the present invention is not interpreted to be limited thereto.

### <Synthesis of Sulfide-Based Inorganic Solid Electrolyte>

### —Synthesis of Li—P—S-Based Glass—

As a sulfide-based inorganic solid electrolyte, Li—P—S-based glass was synthesized with reference to a non-patent document of T. Ohtomo, A. Hayashi, M. Tatsumisago, Y. Tsuchida, S. HamGa, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed, injected into an agate mortar, and mixed using an agate muddler for five minutes. The mixing ratio between Li₂S and P₂S₅ was set to 75:25 in terms of molar ratio.

Zirconia beads (66 g) having a diameter of 5 mm were injected into a 45 mL zirconia container (manufactured by Fritsch Japan Co., Ltd.), the full amount of the mixture of the lithium sulfide and the diphosphorus pentasulfide was injected thereinto, and the container was sealed in an argon atmosphere. The container was set in a planetary ball mill P-7 (trade name, manufactured by Fritsch Japan Co., Ltd.) manufactured by Fritsch Japan Co., Ltd., mechanical milling was carried out at a temperature of 25° C. and a rotation speed of 510 rpm for 20 hours, thereby obtaining yellow powder (6.10 g) of Li—P—S-based glass. The ion conductivity of the Li—P—S-based glass was 0.9×10⁻³ S/cm.

Meanwhile, the ion conductivity of the sulfide-based inorganic solid electrolyte was measured using the following method.

### (Method for Computing Ion Conductivity of Sulfide-Based Inorganic Solid Electrolyte)

The sulfide-based inorganic solid electrolyte synthesized above (100 mg) was measured, injected into a pressure molding device capable of molding a workpiece to a round shape having a diameter of 12 mm, and pressurized at 360 MPa, thereby obtaining a sulfide-based inorganic solid electrolyte compact having a diameter of 12 mm. This compact was interposed between stainless steel electrode plates, thereby producing a cell for electrochemical measurement.

The obtained cell for electrochemical measurement was measured using an alternating current impedance method, thereby obtaining the ion conduction resistance (R(ion)) of the sulfide-based inorganic solid electrolyte compact.

From the following expression, the ion conductivity of the sulfide-based inorganic solid electrolyte was obtained.

Ion conductivity of sulfide-based inorganic solid electrolyte=thickness (cm) of sulfide-based inorganic solid electrolyte compact/(R(ion)×area of sulfide-based inorganic solid electrolyte compact (radiusxradius×π) (cm²))

The Log P values and the numbers of carbon atoms of dispersion media or the numbers of ether bonds in one molecule of the organic compounds (B) used in examples and comparative examples are shown in Table 1.

TABLE 1

| | | Number of |
|---|---|---|
| Dispersion medium | Log P | carbon atoms |
| Acetonitrile | 0.17 | 2 |
| Ethyl acetate | 0.29 | 4 |
| Acetone | 0.2 | 3 |
| N-methyl-2-pyrrolidone (NMP) | −0.34 | 5 |
| Ethanol | 0.07 | 2 |
| Ethylene glycol diacetate | −0.3 | 6 |
| Hexane | 3.0 | 6 |
| Butyronitrile | 1.24 | 4 |
| Dibutyl ether | 2.57 | 8 |
| Diisopropyl ketone | 2.64 | 7 |

Continue from Table 1

| | | Number of |
|---|---|---|
| Dispersion medium | Log P | ether bonds |
| Diethylene glycol dimethyl ether | −0.22 | 3 |
| Triethylene glycol dimethyl ether | −0.38 | 4 |
| Tetraethylene glycol dimethyl ether | −0.52 | 5 |

### <Preparation of Lithium (Li) Salt Solution>

A rotor and acetonitrile (100 g) were injected into a 300 mL egg-plant flask in a glove box filled with argon, and, furthermore, LiTFS (170 g) was measured as a lithium salt and injected thereinto. The components were stirred using a stirrer while being heated at 50° C., thereby obtaining a lithium salt solution A001 that became transparent after one hour.

Lithium salt solutions A002 to A014, A101 to A103, and cA001 to cA003 were produced in the same manner as in the preparation of the lithium salt solution A001 except for the fact that the compositions in Table 2 were employed.

Here, in cA002, the lithium salt settled out, did not dissolve, and remained.

TABLE 2

| | | Amount | | Amount | Amount |
|---|---|---|---|---|---|
| | | mixed | Li salt | mixed | mixed |
| No. | Organic compound (B) | (1) | (C) | (2) | (3) |
| A001 | Acetonitrile (20 ppm) | 100 | LiTFSI | 70 | 0.10 |
| A002 | Acetonitrile (20 ppm) | 100 | LiFSI | 50 | 0.22 |
| A003 | Ethyl acetate (30 ppm) | 100 | LiFSI | 40 | 0.19 |
| A004 | Acetone (100 ppm) | 100 | LiTFSI | 70 | 0.14 |
| A006 | NMP (100 ppm) | 100 | LiTFSI | 50 | 0.17 |
| A007 | Ethanol (50 ppm) | 100 | LiFSI | 50 | 0.12 |
| A008 | Acetonitrile (20 ppm) | 100 | LiBETI | 100 | 0.11 |
| A009 | Acetonitrile (20 ppm) | 100 | LiBETI | 900 | 0.95 |
| A010 | Ethanol (50 ppm) | 100 | LiTFSI | 80 | 0.13 |
| A011 | Ethanol (50 ppm) | 100 | LiTFSI | 650 | 1.04 |
| A013 | Acetonitrile (10,000 ppm) | 100 | LiTFSI | 70 | 0.10 |
| A014 | Ethylene glycol diacetate | 100 | LiTFSI | 50 | 0.25 |
| | (100 ppm) | | | | |
| cA001 | Acetonitrile (20 ppm) | 100 | LiTFSI | 20 | 0.03 |
| cA002 | Hexane (8 ppm) | 100 | LiFSI | 40 | 0.18 |
| cA003 | Ethanol (50 ppm) | 100 | — | 0 | 0.00 |

Continue from Table 2

| | | | | | |
|---|---|---|---|---|---|
| A101 | Diethylene glycol dimethyl | 100 | LiTFSI | 200 | 0.93 |
| | ether (700 ppm) | | | | |
| A102 | Triethylene glycol dimethyl | 100 | LiTFSI | 161 | 1.00 |
| | ether (1,300 ppm) | | | | |
| A103 | Tetraethylene glycol | 100 | LiTFSI | 129 | 1.00 |
| | dimethyl ether (2,500 ppm) | | | | |

<Notes of table>
Amount mixed (1) indicates the gram of the organic compound (B).
Amount mixed (2) indicates the gram of the lithium salt (C).
Amount mixed (3) indicates the number of moles of the lithium salt (C) with respect to 1 mol of the organic compound (B).
Numerical values in parentheses in the column of the organic compound (B) indicate the (mass-based) amount of water included in the organic compound (B).

### <Method for Measuring Water Content Rate of Organic Compound (B)>

The organic compound (B) (10 mL) was sealed in a syringe in a glove box and directly injected into a Karl Fischer measurement instrument, thereby measuring the water content rate. The amount injected was computed from the difference in the syringe weight before and after the injection of the organic compound.

Karl Fischer measurement instrument: MKC-610 (trade name, manufactured by Kyoto electronics Manufacturing Co., Ltd.)

Anode solution: AQUAMICRON AX 100 mL

Counter electrode solution: AQUAMICRON CXU 5 mL

(all trade name, manufactured by Mitsubishi Chemical Corp.)

### <Preparation Example of Solid Electrolyte Composition>

### —Preparation of Solid Electrolyte Composition S-1—

One hundred and eighty zirconia beads having a diameter of 5 mm were injected into a 45 mL zirconia container (manufactured by Fritsch Japan Co., Ltd.), and the Li-P-S-based glass synthesized above (9.7 g), a copolymer of polyvinylene difluoride and hexafluoropropylene (PVdF-HFP) (manufactured by Arkema K. K.) (0.3 g) as a binder, and the lithium salt solution A001 prepared above (15 g) were injected thereinto. After that, the container was set in a planetary ball mill P-7 (trade name, manufactured by Fritsch Japan Co., Ltd.), and the components were continuously stirred at a temperature of 25° C. and a rotation speed of 300 rpm for two hours. A solid electrolyte composition S-1 was prepared as described above.

—Preparation of Solid Electrolyte Compositions S-2 to S-12, S-14 to S-16, S-101 to S-103, and cS-1 to cS-3—

Solid electrolyte compositions S-2 to S-12, S-14 to S-16, S-101 to S-103, and cS-1 to cS-3 were prepared in the same manner as in the preparation of the solid electrolyte composition S-1 except for the fact that the compositions in Table 3 were employed.

### —Preparation of Solid Electrolyte Composition S-13—

One hundred and eighty zirconia beads having a diameter of 5 mm were injected into a 45 mL zirconia container (manufactured by Fritsch Japan Co., Ltd.), and the Li—P—S-based glass synthesized above (9.7 g), a copolymer of polyvinylene difluoride and hexafluoropropylene (PVdF-HFP) (manufactured by Arkema K. K.) (0.3 g) as a binder, the lithium salt solution A009 prepared above (15 g), and dibutyl ether (10 g) were injected thereinto. After that, the container was set in a planetary ball mill P-7 (trade name, manufactured by Fritsch Japan Co., Ltd.), and the components were continuously stirred at a temperature of 25° C. and a rotation speed of 300 rpm for two hours. A solid electrolyte composition S-13 was prepared as described above.

—Preparation of Solid Electrolyte Composition cS-4—

The Li—P—S-based glass synthesized above (9.5 g), a copolymer of polyvinylene difluoride and hexafluoropropylene (PVdF-HFP) (manufactured by Arkema K. K.) (0.4 g) as a binder, LiTFSI (0.1 g) as a lithium salt, and heptane (Log P value: 3.42) as a dispersion medium (15 g) were injected into a container. After that, the container was set in a planetary ball mill P-7 (trade name, manufactured by Fritsch Japan Co., Ltd.), and the components were continuously stirred at a temperature of 25° C. and a rotation speed of 300 rpm for two hours. A solid electrolyte composition cS-4 was prepared as described above.

In Table 3, the solid electrolyte compositions Nos. S-1 to S-16 and S-101 to S-103 are examples, and the solid electrolyte compositions Nos. cS-1 to cS-4 are comparative examples.

TABLE 3

| | | | | | Second | | | Amount of residual |
|---|---|---|---|---|---|---|---|---|
| Solid electrolyte | | | Li salt | | dispersion | | Amount of Li salt | organic compound |
| composition | (A) | (D) | solution | Content (%) | medium | Content (%) | (% by mass) | (ppm (mass-based)) |
| S-1 | 9.7 | 0.3 | A001 | 15 | — | — | 38.2 | 300 |
| S-2 | 9.7 | 0.3 | A002 | 15 | — | — | 33.3 | 300 |
| S-3 | 9.7 | 0.3 | A003 | 15 | — | — | 30.0 | 50 |
| S-4 | 9.7 | 0.3 | A004 | 15 | — | — | 38.2 | 300 |
| S-6 | 9.7 | 0.3 | A006 | 15 | — | — | 33.3 | 300 |
| S-7 | 9.7 | 0.3 | A007 | 15 | — | — | 33.3 | 300 |
| S-8 | 9.7 | 0.3 | A008 | 15 | — | — | 42.9 | 300 |
| S-9 | 9.7 | 0.3 | A009 | 15 | — | — | 57.4 | 25000 |
| S-10 | 9.7 | 0.3 | A010 | 15 | — | — | 40.0 | 300 |
| S-11 | 9.7 | 0.3 | A011 | 15 | — | — | 56.5 | 600 |
| S-13 | 9.7 | 0.3 | A009 | 15 | Dibutyl ether | 10 | 57.4 | 300 |
| S-14 | 9.7 | 0.3 | A013 | 15 | — | — | 38.2 | 300 |
| S-15 | 9.7 | 0.3 | A014 | 15 | — | — | 33.3 | 400 |
| S-16 | 10 | 0 | A001 | 15 | — | — | 38.2 | 90 |
| cS-1 | 9.7 | 0.3 | cA001 | 15 | — | — | 20.0 | 600 |
| cS-2 | 9.7 | 0.3 | cA002 | 15 | — | — | 30.0 | 300 |
| cS-3 | 9.7 | 0.3 | cA003 | 15 | — | — | 0.0 | 600 |
| cS-4 | 9.5 | 0.4 | — | — | — | — | 38.2 | 100 or less |
| S-101 | 9.7 | 0.3 | A101 | 20 | — | — | 57.1 | 200 |
| S-102 | 9.7 | 0.3 | A102 | 20 | — | — | 55.2 | 500 |
| S-103 | 9.7 | 0.3 | A103 | 20 | — | — | 53 | 1500 |

<Notes of table>
“—” in the table indicates that the corresponding component is not included or the like.
(A): The content (g) of the sulfide-based inorganic solid electrolyte (A)
(D): The content (g) of PVdF-HFP as the binder (D)
The amount of the Li salt and the amount of the residual organic compound refer to the amounts in a solid electrolyte layer formed of the solid electrolyte composition described below. Meanwhile, the amount of the residual organic compound is the total of the amounts of the organic compound (B) and a second dispersion medium.

### <Preparation Example of Composition for Positive Electrode>

### —Preparation of Composition for Positive Electrode AS-1—

Fifty zirconia beads having a diameter of 3 mm were injected into a 45 mL zirconia container (manufactured by Fritsch Japan Co., Ltd.), and the solid electrolyte composition S-1 prepared above (2.5 g) was added thereto. A positive electrode active material NMC (111) (4.37 g) and a conductive auxiliary agent (acetylene black) (0.09 g) were added thereto, and, furthermore, dibutyl ether (1 g) was added thereto as the second dispersion medium. This container was set in a planetary ball mill P-7 (trade name, manufactured by Fritsch Japan Co., Ltd.), and the components were continuously stirred at a temperature of 25° C. and a rotation speed of 100 rpm for 15 minutes, thereby preparing a composition for a positive electrode AS-1.

—Preparation of Compositions for Positive Electrode AS-2 to AS-17, AS-101 to AS-104, and cAS-1 to cAS-3—

Compositions for a positive electrode AS-2 to AS-17, AS-101 to AS-104, and cAS-1 to cAS-3 were prepared in the same manner as in the preparation of the composition for a positive electrode AS-1 except for the fact that the compositions in Table 4 were employed.

—Preparation of Composition for Positive Electrode cAS-4—

A positive electrode active material NMC (111) (4.37 g), acetylene black (0.22 g), the solid electrolyte composition No. cS-4 obtained above (3.3 g), and heptane (12 g) were added to a planetary mixer (trade name: TK HIVIS MIX manufactured by Primix Corporation), and the components were stirred at a temperature of 25° C. and a rotation speed of 40 rpm for one hour, thereby preparing a composition for a positive electrode cAS-4.

In Table 4, the compositions for a positive electrode Nos. AS-1 to AS-17 and AS-101 to AS-104 are examples, and the compositions for a positive electrode Nos. cAS-1 to cAS-4 are comparative examples.

TABLE 4

| Composition for | | | | Conductive | | | | Amount of residual |
|---|---|---|---|---|---|---|---|---|
| positive | Active | Solid electrolyte | | auxiliary | Second dispersion | Amount | Amount of Li salt | organic compound |
| electrode | material | composition | | agent | medium | mixed | (% by mass) | (ppm (mass-based)) |
| AS-1 | 4.37 g | S-1 | 2.5 g | 0.09 g | Dibutyl ether | 1 g | 10.2 | 100 |
| AS-2 | 4.37 g | S-2 | 2.5 g | 0.09 g | Butyronitrile | 1 g | 8.4 | 100 |
| AS-3 | 4.37 g | S-3 | 2.5 g | 0.09 g | — | 0 g | 7.3 | 15 |
| AS-4 | 4.37 g | S-4 | 2.5 g | 0.09 g | Diisopropyl | 1 g | 10.2 | 90 |
| | | | | | ketone | | | |
| AS-6 | 4.37 g | S-6 | 2.5 g | 0.09 g | — | 0 g | 8.4 | 100 |
| AS-7 | 4.37 g | S-7 | 2.5 g | 0.09 g | — | 0 g | 8.4 | 100 |
| AS-8 | 4.37 g | S-8 | 2.5 g | 0.09 g | Diisopropyl | 1 g | 12.1 | 100 |
| | | | | | ketone | | | |
| AS-9 | 4.37 g | S-9 | 2.5 g | 0.09 g | Dibutyl ether | 2 g | 19.8 | 9000 |
| AS-10 | 4.37 g | S-10 | 2.5 g | 0.09 g | Butyronitrile | 1 g | 10.9 | 100 |
| AS-11 | 4.37 g | S-11 | 2.5 g | 0.09 g | Diisopropyl | 2 g | 19.2 | 200 |
| | | | | | ketone | | | |
| AS-13 | 4.37 g | S-13 | 2.5 g | 0.09 g | Dibutyl ether | 1 g | 15.7 | 100 |
| AS-14 | 4.37 g | S-14 | 2.5 g | 0.09 g | Diisopropyl | 1 g | 10.2 | 100 |
| | | | | | ketone | | | |
| AS-15 | 4.37 g | S-14 | 2.5 g | 0 g | Diisopropyl | 1 g | 10.3 | 100 |
| | | | | | ketone | | | |
| AS-16 | 4.37 g | S-15 | 2.5 g | 0.09 g | Dibutyl ether | 1 g | 8.4 | 50 |
| AS-17 | 4.37 g | S-16 | 2.5 g | 0.09 g | Dibutyl ether | 1 g | 10.2 | 100 |
| cAS-1 | 4.37 g | cS-1 | 2.5 g | 0.09 g | — | 0 g | 4.4 | 200 |
| cAS-2 | 4.37 g | cS-2 | 2.5 g | 0.09 g | — | 0 g | 7.3 | 100 |
| cAS-3 | 4.37 g | cS-3 | 2.5 g | 0.09 g | — | 0 g | 0.0 | 200 |
| cAS-4 | 4.37 g | cS-4 | 3.3 g | 0.22 g | Heptane | 12 g | 0.4 | 10 or less |
| AS-101 | 4.37 g | S-101 | 2.5 g | 0.09 g | — | 0 g | 17.3 | 100 |
| AS-102 | 4.37 g | S-102 | 2.5 g | 0.09 g | Dibutyl ether | 1 g | 16.3 | 100 |
| AS-103 | 4.37 g | S-103 | 2.5 g | 0.09 g | Diisopropyl ketone | 1 g | 15.1 | 2000 |
| AS-104 | 4.37 g | S-103 | 2.5 g | 0.09 g | — | 0 g | 15.1 | 2000 |

<Notes of table>
In all of the compositions for a positive electrode, NMC (111) was used as an active material. NMC (111) stands for Li(Ni_{1/3}Mn_{1/3}Co_{1/3})O₂, and “111” indicates the compositional fractions of Ni, Mn, and Co.
As the conductive auxiliary agent, acetylene black was used.
“—” in the table indicates that the corresponding component is not included or the like.
The amount of the Li salt and the amount of the residual organic compound refer to the amounts in a positive electrode active material layer formed of the composition for a positive electrode described below. Meanwhile, the amount of the residual organic compound is the total of the amounts of the organic compound (B) and the second dispersion medium.

### —Preparation of Composition for Negative Electrode BS-1—

Fifty zirconia beads having a diameter of 3 mm were injected into a 45 mL zirconia container (manufactured by Fritsch Japan Co., Ltd.), and the solid electrolyte composition S-1 prepared above (2.5 g) was added thereto. A negative electrode active material (graphite) (4.2 g) was added thereto, and, furthermore, dibutyl ether (1 g) was added thereto as the second dispersion medium. This container was set in a planetary ball mill P-7 (trade name, manufactured by Fritsch Japan Co., Ltd.), and the components were continuously stirred at a temperature of 25° C. and a rotation speed of 100 rpm for 15 minutes, thereby preparing a composition for a negative electrode BS-1.

—Preparation of Compositions for Negative Electrode BS-2 to BS-16, BS-101 to BS-104, and cBS-1 to cBS-3—

Compositions for a negative electrode BS-2 to BS-16, BS-101 to BS-104, and cBS-1 to cBS-3 were prepared in the same manner as in the preparation of the composition for a negative electrode BS-1 except for the fact that the compositions in Table 5 were employed.

—Preparation of Composition for Negative Electrode cBS-4—

A negative electrode active material (graphite) (4.2 g), acetylene black (0.2 g), the solid electrolyte composition No. cS-4 obtained above (3.2 g), and heptane (11.3 g) were added to a planetary mixer (trade name: TK HIVIS MIX manufactured by Primix Corporation), and the components were stirred at a temperature of 25° C. and a rotation speed of 40 rpm for one hour, thereby preparing a composition for a negative electrode cBS-4.

In Table 5, the compositions for a negative electrode Nos. BS-1 to BS-16 and BS-101 to BS-104 are examples, and the compositions for a negative electrode Nos. cBS-1 to cBS-4 are comparative examples.

TABLE 5

| Composition for | | | | | | | Amount of residual |
|---|---|---|---|---|---|---|---|
| negative | Active | Solid electrolyte | | Second dispersion | Amount | Amount of Li salt | organic compound |
| electrode | material | composition | | medium | mixed | (% by mass) | (ppm (mass-based)) |
| BS-1 | 4.2 g | S-1 | 2.5 g | Dibutyl ether | 1 g | 10.6 | 200 |
| BS-2 | 4.2 g | S-2 | 2.5 g | Butyronitrile | 1 g | 8.8 | 160 |
| BS-3 | 4.2 g | S-3 | 2.5 g | — | 0 g | 7.6 | 10 |
| BS-4 | 4.2 g | S-4 | 2.5 g | Diisopropyl ketone | 1 g | 10.6 | 100 |
| BS-6 | 4.2 g | S-6 | 2.5 g | — | 0 g | 8.8 | 150 |
| BS-7 | 4.2 g | S-7 | 2.5 g | — | 0 g | 8.8 | 120 |
| BS-8 | 4.2 g | S-8 | 2.5 g | Diisopropyl ketone | 1 g | 12.6 | 120 |
| BS-9 | 4.2 g | S-9 | 2.5 g | Dibutyl ether | 2g | 20.6 | 9200 |
| BS-10 | 4.2 g | S-10 | 2.5 g | Butyronitrile | 1 g | 11.4 | 140 |
| BS-11 | 4.2 g | S-11 | 2.5 g | Diisopropyl ketone | 2g | 20.0 | 220 |
| BS-13 | 4.2 g | S-13 | 2.5 g | Dibutyl ether | 1 g | 16.4 | 200 |
| BS-14 | 4.2 g | S-14 | 2.5 g | Diisopropyl ketone | 1 g | 10.6 | 100 |
| BS-15 | 4.2 g | S-15 | 2.5 g | Dibutyl ether | 1 g | 8.8 | 100 |
| BS-16 | 4.2 g | S-16 | 2.5 g | Dibutyl ether | 1 g | 10.6 | 100 |
| cBS-1 | 4.2 g | cS-1 | 2.5 g | — | 0 g | 4.6 | 600 |
| cBS-2 | 4.2 g | cS-2 | 2.5 g | — | 0 g | 7.6 | 100 |
| cBS-3 | 4.2 g | cS-3 | 2.5 g | — | 0 g | 0.0 | 300 |
| cBS-4 | 4.2 g | cS-4 | 3.2 g | Heptane | 11.3 g | 0.4 | 10 or less |
| BS-101 | 4.2 g | S-101 | 2.5 g | — | 0 g | 18.1 | 0.02 |
| BS-102 | 4.2 g | S-102 | 2.5 g | Dibutyl ether | 1 g | 17.0 | 0.016 |
| BS-103 | 4.2 g | S-103 | 2.5 g | Diisopropyl ketone | 1 g | 15.7 | 0.001 |
| BS-104 | 4.2 g | S-103 | 2.5 g | — | 0 g | 15.7 | 1 |

<Notes of table>
In all of the compositions for a negative electrode, graphite was used as an active material.
“—” in the table indicates that the corresponding component is not included or the like.
The amount of the Li salt and the amount of the residual organic compound refer to the amounts in a positive electrode active material layer formed of the composition for a positive electrode described below. Meanwhile, the amount of the residual organic compound is the total of the amounts of the organic compound (B) and the second dispersion medium.

### <Method for Measuring Amount of Li Salt in Each Layer>

Measurement was carried out using a solution ¹Li—NMR method.

After the formation and before the lamination of individual layers described below, each layer (1 g) was peeled off in a glove box and stirred in a mortar for five minutes, thereby obtaining the powder of the layer. Heavy water (D₂O) (10 g) to which lithium chloride was added as an internal standard material was added thereto, and the components were stirred at room temperature for 30 minutes. After a solid component was filtered, a ¹Li—NMR measurement was carried out, a calibration curve of the correlation between the ¹Li—NMR peak area and the amount of the organic compound (B) was produced, and the amount of the residual dispersion medium was computed.

### <Method for Measuring Amount of Residual Organic Compound (B) in Each Layer>

Measurement was carried out using a solution ¹H—NMR method.

After the formation and before the lamination of the individual layers described below, each layer (1 g) was peeled off in a glove box and stirred in a mortar for five minutes, thereby obtaining the powder of the layer. Heavy water (D₂O) (10 g) to which maleic acid was added as an internal standard material was added thereto, and the components were stirred at room temperature for 30 minutes. After a solid component was filtered, a ¹H—NMR measurement was carried out, a calibration curve of the correlation between the ¹H—NMR peak area and the amount of the organic compound (B) was produced, and the amount of the residual dispersion medium was computed.

### <Production Example of Positive Electrode Sheet for All-Solid State Secondary Battery>

The composition for a positive electrode cAS-2 prepared above was applied onto a 20 μm-thick aluminum foil (collector) using an applicator (trade name: SA-201 Baker type applicator, manufactured by Tester Sangyo Co., Ltd.), heated at 80° C. for one hour, and then further heated at 110° C. for one hour, and the composition for a positive electrode was dried. After that, the composition for a positive electrode was heated (at 120° C.) and pressurized (at 180 MPa for one minute) using a heat press machine, thereby producing a positive electrode sheet for an all-solid state secondary battery having a laminate structure of a positive electrode active material layer and the aluminum foil. The thickness of the positive electrode active material layer was 90 μm.

### <Production Example of All-Solid State Secondary Battery>

Two kinds of an all-solid state secondary battery No. 101 having the layer constitution illustrated in FIG. 1 were produced.

### <Production of All-Solid State Secondary Battery Sheet>

The solid electrolyte composition cS-2 prepared above was applied onto the positive electrode active material layer of the positive electrode sheet for an all-solid state secondary battery obtained above using the Baker type applicator, heated at 80° C. for one hour, and further heated at 100° C. for one hour, thereby forming a 100 μm-thick solid electrolyte layer.

Next, the composition for a negative electrode BS-1 prepared above was applied onto the obtained solid electrolyte layer using the Baker type applicator, heated at 80° C. for one hour, and then further heated at 110° C. for one hour, thereby forming a 100 μm-thick negative electrode active material layer. A 20 μm-thick copper foil was overlaid on the negative electrode active material layer, and the copper foil and the negative electrode active material layer were heated at 120° C. and pressurized (at 600 MPa for one minute) using a heat press machine, thereby producing an all-solid state secondary battery sheet No. 101 shown in Table 6. In this all-solid state secondary battery sheet, the capacity of the negative electrode was 1.2 times the capacity of the positive electrode.

“An all-solid state secondary battery sheet No. 101 in which the capacity of the negative electrode was 1.01 times the capacity of the positive electrode” was produced in the same manner as “the all-solid state secondary battery sheet No. 101 in which the capacity of the negative electrode was 1.2 times the capacity of the positive electrode” except for the fact that a 85 μm-thick negative electrode active material layer was formed instead of forming a 100 μm layer during the production of the negative electrode active material layer.

### (Production of All-Solid State Secondary Battery)

A disc-shaped piece having a diameter of 14.5 mm was cut out from each of the all-solid state secondary batteries obtained above. An all-solid state secondary battery sheet 17 having a diameter of 14.5 mm that had been cut out to a diameter of 14.5 mm was put into a stainless steel 2032-type coin case 16 illustrated in FIG. 2 in which a spacer and a washer (bot not illustrated in FIG. 2) were combined together, and the 2032-type coin case 16 was swaged (tightening force: 0.1 MPa), thereby producing two all-solid state secondary batteries 18 No. 101 having the layer constitution illustrated in FIG. 1. That is, “an all-solid state secondary battery sheet No. 101 in which the capacity of the negative electrode was 1.2 times the capacity of the positive electrode” and “an all-solid state secondary battery sheet No. 101 in which the capacity of the negative electrode was 1.01 times the capacity of the positive electrode” were produced.

Two kinds of each of the all-solid state secondary batteries with different serial numbers in Tables 6 to 8 were produced in the same manner as the all-solid state secondary battery No. 101.

### <Testing>

On the all-solid state secondary batteries produced above, the following cycle characteristic test was carried out. The testing method is described below. The results are summarized in Tables 6 to 8.

### —Cycle Characteristic (0° C.)—

Using the all-solid state secondary battery produced above in which the capacity of the negative electrode was 1.2 times the capacity of the positive electrode, charging and discharging of 4.2 V to 3.0 V was repeated four times in an environment of 30° C. under conditions of a charge current value of 0.35 mA and a discharge current value of 0.7 mA.

After that, as a cycle test, a test of repeating charging and discharging of 4.2 V to 3.0 V in an environment of 0° C. under conditions of a charge and discharge current value of 0.7 mA was carried out.

The discharge capacity in the first cycle and the discharge capacity in the 100^{th} cycle were measured, and the discharge capacity maintenance percentage was evaluated according to the following evaluation standards. The ranks “C” or higher are pass.

Discharge capacity maintenance percentage (%)=discharge capacity in 100^{th} cycle/discharge capacity in first cycle×100

### —Evaluation Standards—

A: The discharge capacity maintenance percentage is 90% or more to 100%.
B: The discharge capacity maintenance percentage is 75% or more to less than 90%.
C: The discharge capacity maintenance percentage is 50% or more to less than 75%.
D: The discharge capacity maintenance percentage is 35% or more to less than 50%.
E: The discharge capacity maintenance percentage is less than 35%.
   —Cycle Characteristic (N/P ratio: 1.01)—

Using the all-solid state secondary battery produced above in which the capacity of the negative electrode was 1.01 times the capacity of the positive electrode, charging and discharging of 4.2 V to 3.0 V was repeated four times in an environment of 30° C. under conditions of a charge current value of 0.35 mA and a discharge current value of 0.7 mA.

After that, as a cycle test, a test of repeating charging and discharging of 4.2 V to 3.0 V in an environment of 30° C. under conditions of a charge and discharge current value of 0.7 mA was carried out.

The discharge capacity in the first cycle and the discharge capacity in the 100^{th} cycle were measured, and the discharge capacity maintenance percentage was evaluated according to the following evaluation standards. The ranks “C” or higher are pass.

Discharge capacity maintenance percentage (%)=discharge capacity in 100^{th} cycle/discharge capacity in first cycle×100
A: The discharge capacity maintenance percentage is 90% or more to 100%.
B: The discharge capacity maintenance percentage is 75% or more to less than 90%.
C: The discharge capacity maintenance percentage is 50% or more to less than 75%.
D: The discharge capacity maintenance percentage is 35% or more to less than 50%.
E: The discharge capacity maintenance percentage is less than 35%.

TABLE 6

| All solid state | Positive | | | | | | Cycle | N/P ratio 1.01 |
|---|---|---|---|---|---|---|---|---|
| secondary | electrode | Thickness | Solid electrolyte | Thickness | Negative | Thickness | characteristic | Cycle |
| battery | layer | (μm) | layer | (μm) | electrode layer | (μm) | (0° C.) | characteristic |
| 101 | cAS-2 | 90 | cS-2 | 100 | BS-1 | 100/85 | A | A |
| 102 | cAS-2 | 90 | cS-2 | 100 | BS-2 | 100/85 | A | B |
| 103 | cAS-2 | 90 | cS-2 | 100 | BS-3 | 100/85 | A | A |
| 104 | cAS-2 | 90 | cS-2 | 100 | BS-4 | 100/85 | A | A |
| 106 | cAS-2 | 90 | cS-2 | 100 | BS-6 | 100/85 | A | A |
| 107 | cAS-2 | 90 | cS-2 | 100 | BS-7 | 100/85 | A | A |
| 108 | cAS-2 | 90 | cS-2 | 100 | BS-8 | 100/85 | A | B |
| 109 | cAS-2 | 90 | cS-2 | 100 | BS-9 | 100/85 | B | B |
| 110 | cAS-2 | 90 | cS-2 | 100 | BS-10 | 100/05 | B | A |
| 111 | cAS-2 | 90 | cS-2 | 100 | BS-11 | 100/85 | B | A |
| 113 | cAS-2 | 90 | cS-2 | 100 | BS-13 | 100/85 | B | A |
| 114 | cAS-2 | 90 | cS-2 | 100 | BS-14 | 100/85 | C | B |
| 115 | cAS-2 | 90 | cS-2 | 100 | BS-15 | 100/85 | B | B |
| 116 | cAS-2 | 90 | cS-2 | 100 | BS-16 | 100/85 | B | C |
| c101 | cAS-2 | 90 | cS-2 | 100 | cBS-1 | 100/85 | E | D |
| c102 | cAS-2 | 90 | cS-2 | 100 | cBS-2 | 100/85 | D | E |
| c103 | cAS-2 | 90 | cS-2 | 100 | cBS-3 | 100/85 | E | D |
| c104 | cAS-2 | 90 | cS-2 | 100 | cBS-4 | 100/85 | E | D |
| 121 | cAS-2 | 90 | cS-2 | 100 | BS-101 | 100/85 | B | B |
| 122 | cAS-2 | 90 | cS-2 | 100 | BS-102 | 100/85 | A | A |
| 123 | cAS-2 | 90 | cS-2 | 100 | BS-103 | 100/85 | A | A |
| 124 | cAS-2 | 90 | cS-2 | 100 | BS-104 | 100/85 | B | A |

TABLE 7

| All solid state | Positive | | | | Negative | | Cycle | N/P ratio 1.01 |
|---|---|---|---|---|---|---|---|---|
| secondary | electrode | Thickness | Solid electrolyte | Thickness | electrode | Thickness | characteristic | Cycle |
| battery | layer | (μm) | layer | (μm) | layer | (μm) | (0° C.) | characteristic |
| 201 | AS-1 | 90 | cS-2 | 100 | cBS-2 | 100/85 | A | A |
| 202 | AS-2 | 90 | cS-2 | 100 | cBS-2 | 100/85 | A | A |
| 203 | AS-3 | 90 | cS-2 | 100 | cBS-2 | 100/85 | A | B |
| 204 | AS-4 | 90 | cS-2 | 100 | cBS-2 | 100/85 | A | A |
| 206 | AS-6 | 90 | cS-2 | 100 | cBS-2 | 100/85 | B | A |
| 207 | AS-7 | 90 | cS-2 | 100 | cBS-2 | 100/85 | A | A |
| 208 | AS-8 | 90 | cS-2 | 100 | cBS-2 | 100/85 | A | B |
| 209 | AS-9 | 90 | cS-2 | 100 | cBS-2 | 100/85 | B | B |
| 210 | AS-10 | 90 | cS-2 | 100 | cBS-2 | 100/85 | A | A |
| 211 | AS-11 | 90 | cS-2 | 100 | cBS-2 | 100/85 | B | A |
| 213 | AS-13 | 90 | cS-2 | 100 | cBS-2 | 100/85 | B | A |
| 214 | AS-14 | 90 | cS-2 | 100 | cBS-2 | 100/85 | C | C |
| 215 | AS-15 | 90 | cS-2 | 100 | cBS-2 | 100/85 | B | B |
| 216 | AS-16 | 90 | cS-2 | 100 | cBS-2 | 100/85 | B | C |
| c201 | cAS-1 | 90 | cS-2 | 100 | cBS-2 | 100/85 | D | D |
| c202 | cAS-3 | 90 | cS-2 | 100 | cBS-2 | 100/85 | E | E |
| c203 | cAS-4 | 90 | cS-2 | 100 | cBS-2 | 100/85 | E | D |
| 221 | AS-101 | 90 | cS-2 | 100 | cBS-2 | 100/85 | B | B |
| 222 | AS-102 | 90 | cS-2 | 100 | cBS-2 | 100/85 | B | A |
| 223 | AS-103 | 90 | cS-2 | 100 | cBS-2 | 100/85 | A | A |
| 224 | AS-104 | 90 | cS-2 | 100 | cBS-2 | 100/85 | B | B |

TABLE 8

| All solid state | Positive | | | | Negative | | Cycle | |
|---|---|---|---|---|---|---|---|---|
| secondary | electrode | Thickness | Solid electrolyte | Thickness | electrode | Thickness | characteristic | N/P ratio 1.01 |
| battery | layer | (μm) | layer | (μm) | layer | (μm) | (0° C.) | Cycle characteristic |
| 301 | cAS-2 | 90 | S-1 | 100 | cBS-2 | 100/85 | A | B |
| 302 | cAS-2 | 90 | S-2 | 100 | cBS-2 | 100/85 | B | B |
| 303 | cAS-2 | 90 | S-3 | 100 | cBS-2 | 100/85 | B | C |
| 304 | cAS-2 | 90 | S-4 | 100 | cBS-2 | 100/85 | B | B |
| 306 | cAS-2 | 90 | S-6 | 100 | cBS-2 | 100/85 | C | B |
| 307 | cAS-2 | 90 | S-7 | 100 | cBS-2 | 100/85 | B | B |
| 308 | cAS-2 | 90 | S-8 | 100 | cBS-2 | 100/85 | B | C |
| 309 | cAS-2 | 90 | S-9 | 100 | cBS-2 | 100/85 | B | C |
| 310 | cAS-2 | 90 | S-10 | 100 | cBS-2 | 100/85 | B | A |
| 311 | cAS-2 | 90 | S-11 | 100 | cBS-2 | 100/85 | B | C |
| 313 | cAS-2 | 90 | S-13 | 100 | cBS-2 | 100/85 | B | C |
| 314 | cAS-2 | 90 | S-14 | 100 | cBS-2 | 100/85 | C | C |
| 315 | cAS-2 | 90 | S-15 | 100 | cBS-2 | 100/85 | B | B |
| 316 | cAS-2 | 90 | S-16 | 100 | cBS-2 | 100/85 | A | C |
| c301 | cAS-2 | 90 | cS-1 | 100 | cBS-2 | 100/85 | E | E |
| c302 | cAS-2 | 90 | cS-3 | 100 | cBS-2 | 100/85 | E | E |
| c303 | cAS-2 | 90 | cS-4 | 100 | cBS-2 | 100/85 | E | E |
| 321 | cAS-2 | 90 | S-101 | 100 | cBS-2 | 100/85 | B | B |
| 322 | cAS-2 | 90 | S-102 | 100 | cBS-2 | 100/85 | B | B |
| 323 | cAS-2 | 90 | S-103 | 100 | cBS-2 | 100/85 | B | A |
| 324 | cAS-2 | 90 | S-104 | 100 | cBS-2 | 100/85 | B | B |

<Notes of table>

In Tables 6 to 8, the thickness of the negative electrode layer “100/85” indicates that, for No. 101 as an example, the thickness of the negative electrode active material layer of “the all-solid state secondary battery No. 101 in which the capacity of the negative electrode was 1,2 times the capacity of the positive electrode” is 100 μm. and the thickness of the negative electrode active material layer of “the all-solid state secondary battery No. 101 in which the capacity of the negative electrode was 1.01 times the capacity of the positive electrode” is 85 μm.

In Tables 6 to 8, all-solid state secondary hattcrics that did not satisfy the regulation of the present invention failed in term of both the cycle characteristic (0° C.) and the cycle characteristic (N/P ratio: 1.01).

In contrast, it is found that the all-solid state secondary battery of the embodiment of the present invention is excellent in terms of the cycle characteristic (0° C.) and is thus capable of exhibiting a high ion conductivity at a low temperature. In addition, it is found that the all-solid state secondary battery of the embodiment of the present invention is excellent in terms of the cycle characteristic (N/P ratio: 1.01) and is thus capable of maintaining a favorable on conductivity by using the present constitution even in a system in which the expansion and contraction difference of a negative electrode active material layer is great and voids are likely to be generated between an active material and an inorganic solid electrolyte. It is found that the all-solid state secondary battery of the embodiment of the present invention is excellent in terms of all of these two cycle characteristics and is excellent in terms of the ion conductivity in spite of a great expansion and contraction difference of the negative electrode active material layer in a broad temperature difference range.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
16: 2032-type coin case
17: all-solid state secondary battery sheet
18: all-solid state secondary battery

What is claimed is:

1. A solid electrolyte composition comprising:
a sulfide-based inorganic solid electrolyte (A) having a conductivity of an ion of a metal belonging to Group I or II of the periodic table;
an organic compound (B) having log P≤1; and
a lithium salt (C),
wherein 0.1 mol or more of the lithium salt (C) is included with respect to 1 mol of the organic compound (B), and
wherein the organic compound (B) has a cyano group, a hydroxy group, an ester bond, an amide bond, a ketone group, and/or a sulfanyl group.

2. The solid electrolyte composition according to claim 1,
wherein the number of carbon atoms in the organic compound (B) is 1 or more and 5 or less.

3. A solid electrolyte composition comprising:
a sulfide-based inorganic solid electrolyte (A) having a conductivity of an ion of a metal belonging to Group I or II of the periodic table;
an organic compound (B) having log P≤1; and
a lithium salt (C),
wherein 0.1 mol or more of the lithium salt (C) is included with respect to 1 mol of the organic compound (B), and
wherein the organic compound (B) has an ether bond.

4. The solid electrolyte composition according to claim 3,
wherein the number of ether bonds in one molecule of the organic compound (B) is 3 or more and 10 or less.

5. The solid electrolyte composition according to claim 4,
wherein the organic compound (B) is a compound represented by General Formula (b), 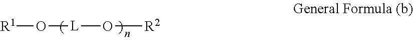
in the formula, R¹ and R² each independently represent a hydrogen atom, an alkyl group, or an aryl group, L represents an alkylene group or an arylene group, R¹ and R² may bond to each other to form a ring, and n represents an integer of 2 or more.

6. The solid electrolyte composition according to claim 5,
wherein a molecular weight of the organic compound (B) is 100 or more and less than 500.

7. The solid electrolyte composition according to claim 5,
wherein, in General Formula (b), R¹ and R² each independently represent an alkyl group or an aryl group.

8. The solid electrolyte composition according to claim 7,
wherein the organic compound (B) is diethylene glycol dimethyl ether, triethylene glycol dimethyl ether, and/or tetraethylene glycol dimethyl ether.

9. The solid electrolyte composition according to claim 1,
wherein a content of water that is included in the organic compound (B) is 1 ppm or more and 1,000 ppm or less on the basis of a mass.

10. The solid electrolyte composition according to claim 1, further comprising:
a binder (D).

11. The solid electrolyte composition according to claim 1, further comprising:
an active material (E).

12. A solid electrolyte-containing sheet comprising:
a sulfide-based inorganic solid electrolyte (A) having a conductivity of an ion of a metal belonging to Group I or II of the periodic table;
a substance derived from an organic compound (B) having log P≤1; and
a lithium salt (C),
wherein 5% by mass or more of the lithium salt (C) is included, and
wherein the organic compound (B) has a cyano group, a hydroxy group, an ester bond, an amide bond, a ketone group, and/or a sulfanyl group.

13. The solid electrolyte-containing sheet according to claim 12,
wherein the number of carbon atoms in the organic compound (B) is 1 or more and 5 or less.

14. A solid electrolyte-containing sheet comprising:
a sulfide-based inorganic solid electrolyte (A) having a conductivity of an ion of a metal belonging to Group I or II of the periodic table;
a substance derived from an organic compound (B) having log P≤1; and
a lithium salt (C),
wherein 5% by mass or more of the lithium salt (C) is included, and
wherein the organic compound (B) has an ether bond.

15. The solid electrolyte-containing sheet according to claim 14,
wherein the number of ether bonds in one molecule of the organic compound (B) is 3 or more and 10 or less.

16. The solid electrolyte-containing sheet according to claim 15,
wherein the organic compound (B) is a compound represented by General Formula (b), 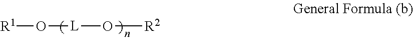
in the formula, R¹ and R² each independently represent a hydrogen atom, an alkyl group, or an aryl group, L represents an alkylene group or an arylene group, R¹ and R² may bond to each other to form a ring, and n represents an integer of 2 or more.

17. The solid electrolyte-containing sheet according to claim 16,
wherein a molecular weight of the organic compound (B) is 100 or more and less than 500.

18. The solid electrolyte-containing sheet according to claim 16,
wherein, in General Formula (b), R¹ and R² each independently represent an alkyl group or an aryl group.

19. The solid electrolyte-containing sheet according to claim 18,
wherein the organic compound (B) is diethylene glycol dimethyl ether, triethylene glycol dimethyl ether, and/or tetraethylene glycol dimethyl ether.

20. The solid electrolyte-containing sheet according to claim 12,
wherein a content of water that is included in the organic compound (B) is 1 ppm or more and 1,000 ppm or less on the basis of a mass.

21. The solid electrolyte-containing sheet according to claim 12,
wherein a content of the organic compound (B) is 10 ppm or more and 10,000 ppm or less on the basis of the mass.

22. The solid electrolyte-containing sheet according to claim 12, further comprising:
a binder (D).

23. The solid electrolyte-containing sheet according to claim 12, further comprising:
an active material (E).

24. An all-solid state secondary battery comprising:
a positive electrode active material layer;
a negative electrode active material layer; and
a solid electrolyte layer,
wherein at least any of the positive electrode active material layer; the negative electrode active material layer, or the solid electrolyte layer is a layer constituted of the solid electrolyte composition according to claim 1.

25. A method for manufacturing the solid electrolyte composition according to claim 1, the method comprising steps (1) and (2),
step (1): a step of mixing the organic compound (B) and the lithium salt (C); and
step (2): a step of mixing the mixture obtained in the step (1) and the sulfide-based inorganic solid electrolyte (A).

26. A method for manufacturing a solid electrolyte-containing sheet, the method comprising:
applying the solid electrolyte composition according to claim 1 onto a base material; and
drying the solid electrolyte composition.

27. A method for manufacturing an all-solid state secondary battery, the method comprising:
manufacturing an all-solid state secondary battery having the solid electrolyte-containing sheet using the manufacturing method according to claim 26.
